(19) United States
(12) Patent Application Publication
(10) Pub. No.: US 2013/0153514 A1
(43) Pub. Date: Jun. 20, 2013

(54) Apparatus and Methods for Treating Fluids Using Ultraviolet Light

(71) Applicants: Eric Stern, Cambridge, MA (US); Graciela B. Blanchet, Boston, MA (US); Shih-Chi Chen, Cambridge, MA (US); Werner Menzi, Maynard, MA (US); Igor Sokolik, East Boston, MA (US); David J. Averbeck, Dousman, WI (US); John Henry Burban, Lake Elmo, MN (US); Phil Rol Chigo, Eden Prairie, MN (US); Boyko Tchavdarov, Aurora, IL (US)

(72) Inventors: Eric Stern, Cambridge, MA (US); Graciela B. Blanchet, Boston, MA (US); Shih-Chi Chen, Cambridge, MA (US); Werner Menzi, Maynard, MA (US); Igor Sokolik, East Boston, MA (US); David J. Averbeck, Dousman, WI (US); John Henry Burban, Lake Elmo, MN (US); Phil Rol Chigo, Eden Prairie, MN (US); Boyko Tchavdarov, Aurora, IL (US)

(73) Assignee: Nano Terra Inc., Brighton, MA (US)

(21) Appl. No.: 13/516,958

(22) PCT Filed: Dec. 17, 2010
(86) PCT No.: PCT/US10/61138

§ 371 Date: Feb. 28, 2013

Related U.S. Application Data
(60) Provisional application No. 61/288,084, filed on Dec. 18, 2009.

(51) Int. Cl. C02F 1/32

(52) U.S. Cl. CPC C02F 1/325
USPC 210/748.1; 250/435

(57) ABSTRACT

The present invention is directed to apparatuses and methods for treating fluids with ultraviolet light, including fluid streams, utilizing elliptical chambers. Suitably, water or other fluids can be disinfected using the chambers. Methods for optimizing irradiation of the fluid in the apparatuses are also provided.

### BACKGROUND OF THE INVENTION

1. Field of the Invention

The present invention is directed to apparatuses and methods for treating fluids with ultraviolet light.

2. Background

Ultraviolet (UV) disinfection of drinking water and waste water has been performed in various forms. Typically, a quartz-shielded UV lamp is placed directly in a stream of water. Although such designs provide high exposure of the water to the UV light, the lamps proximity to the quartz causes it to warm, eventually resulting in mineral deposits that significantly reduce the UV transmittance over time.

### BRIEF SUMMARY OF THE INVENTION

What is needed is an apparatus for treatment of a fluid using ultraviolet (UV) light in which the fluid is irradiated efficiently and without significant warming of the fluid.

The present invention is directed to an apparatus for the treatment of a fluid, comprising: a cylindrical chamber that includes a reflective inner surface, wherein the cylindrical chamber has an elliptical cross-section that includes a major axis; an ultraviolet-transmissive conduit suitable for transmitting a fluid, the ultraviolet-transmissive conduit positioned at a first point on the major axis of the elliptical cross-section and traversing a length of the cylindrical chamber; a mixing system configured to induce mixing of the fluid; a first ultraviolet light source and a second ultraviolet light source positioned within the cylindrical chamber, wherein the first and second ultraviolet light sources are substantially equidistant from the ultraviolet-transmissive conduit and on opposite sides of the major axis of the elliptical cross-section, wherein the first and second ultraviolet light sources provide a non-uniform irradiance of the ultraviolet-transmissive conduit, and wherein substantially all of a fluid flowed through the ultraviolet-transmissive conduit is irradiated by ultraviolet light.

In some embodiments, the first ultraviolet light source and the second ultraviolet light source are equidistant from the major axis of the elliptical cross-section, and the elliptical cross-section has an eccentricity of 0 to 0.5. In some embodiments, the elliptical cross-section has a focal length of 10 mm to 50 mm. In some embodiments, a central point of an axis passing through the centers of the first and second ultraviolet light sources is positioned at a first focus of the elliptical cross-section. In some embodiments, the ultraviolet-transmissive conduit is positioned at a second focus of the elliptical cross-section.

The present invention is also directed to an apparatus for the treatment of a fluid, comprising: a cylindrical chamber having a double-elliptical cross-section provided by partially overlapping first and second ellipses, wherein the ellipses have co-linear major axes and overlapping second focal points, wherein the cylindrical chamber includes a reflective inner surface; an ultraviolet-transmissive conduit suitable for transmitting a fluid, the ultraviolet-transmissive conduit positioned at the overlapping second focal points of the first and second ellipses, wherein the ultraviolet-transmissive conduit traverses a length of the cylindrical chamber; a mixing system configured to induce mixing of the fluid; a first ultraviolet light source and a second ultraviolet light source positioned within the cylindrical chamber, wherein the first and second ultraviolet light sources are substantially equidistant from the ultraviolet-transmissive conduit and on opposite sides of the major axis of the first ellipse of the double-elliptical cross-section; and a third ultraviolet light source and a fourth ultraviolet light source positioned within the cylindrical chamber, wherein the third and fourth ultraviolet light sources are substantially equidistant from the ultraviolet-transmissive conduit and on opposite sides of the major axis of the second ellipse of the double-elliptical cross-section, wherein the first, second, third, and fourth ultraviolet light sources provide a non-uniform irradiance of the ultraviolet-transmissive conduit, and wherein substantially all of a fluid flowed through the ultraviolet-transmissive conduit is irradiated by ultraviolet light.

The present invention is also directed to an apparatus for the treatment of a fluid, comprising: a cylindrical chamber having a double-elliptical cross-section provided by partially overlapping first and second ellipses, wherein the ellipses have co-linear major axes and wherein the cylindrical chamber includes a reflective inner surface; an ultraviolet-transmissive conduit suitable for transmitting a fluid, wherein a first portion of the ultraviolet-transmissive conduit traverses a length of the cylindrical chamber and is positioned at a first point on the major axis of the first ellipse, wherein a second portion of the ultraviolet-transmissive conduit traverses a length of the cylindrical chamber and is positioned at a first point on the major axis of the second ellipse; a mixing system configured to induce mixing of the fluid; a first ultraviolet light source and a second ultraviolet light source positioned within the cylindrical chamber, wherein the first and second ultraviolet light sources are substantially equidistant from the ultraviolet-transmissive conduit and on opposite sides of the major axis of the first ellipse of the double-elliptical cross-section; a third ultraviolet light source and a fourth ultraviolet light source positioned within the cylindrical chamber, wherein the third and fourth ultraviolet light sources are substantially equidistant from the ultraviolet-transmissive conduit and on opposite sides of the major axis of the second ellipse of the double-elliptical cross-section; and a fifth ultraviolet light source positioned within the cylindrical chamber between the first and second portions of the ultraviolet-transmissive conduit and on the overlapping major axes of the first and second ellipses, wherein the first, second, third, fourth, and fifth ultraviolet light sources provide a non-uniform irradiance of the first and second portions of the ultraviolet-transmissive conduit, and wherein substantially all of a fluid flowed through the ultraviolet-transmissive conduit is irradiated by ultraviolet light.

In some embodiments, the first portion of the ultraviolet-transmissive conduit is positioned at a second focus of the first ellipse and the second portion of the ultraviolet-transmissive conduit is positioned at a second focus of the second ellipse. In some embodiments, the first and second ultraviolet light sources are equidistant from the major axis of the first ellipse of the double-elliptical cross-section and the third and fourth ultraviolet light sources are equidistant from the major axis positioned on the major axis of the second ellipse of the double-elliptical cross-section. In some embodiments, a central point of an axis passing through the centers of the first and second ultraviolet light sources is positioned at a first focus of the first ellipse and a central point of an axis passing through the centers of the third and fourth ultraviolet light sources is positioned at a first focus of the second ellipse. In some embodiments, the ultraviolet light sources are U-shaped ultraviolet bulbs, H-shaped ultraviolet bulbs, or a combination thereof.

The present invention is also directed to an apparatus for the treatment of a fluid, comprising: an ultraviolet-transmissive conduit suitable for containing a flowing fluid, the ultraviolet-transmissive conduit positioned within and traversing a length of a cylindrical chamber that includes a reflective inner surface; a mixing system configured to induce mixing of the fluid; and a plurality of ultraviolet light sources positioned in an even distribution around the ultraviolet-transmissive conduit, each ultraviolet light sources including a parabolic reflector, wherein the ultraviolet light sources provide a non-uniform irradiance of the ultraviolet-transmissive conduit, and wherein substantially all of a fluid flowed through the ultraviolet-transmissive conduit is irradiated by ultraviolet light.

In some embodiments, the elliptical cross-section includes a minor axis and the ultraviolet-transmissive conduit and ultraviolet light source(s) are on opposite sides of the minor axis.

In some embodiments, an apparatus of the present invention comprises an ultraviolet-transmissive sheath surrounding the ultraviolet light sources. In some embodiments, an apparatus of the present invention comprises an ultraviolet-transmissive sheath surrounding the conduit. In some embodiments, the substantially reflective inner surface of the cylindrical chamber comprises aluminum.

In some embodiments, the ultraviolet-transmissive conduit has a substantially circular cross-section of 10 mm to 125 mm in diameter. In some embodiments, the ultraviolet-transmissive conduit has a length of 10 cm to 300 cm. In some embodiments, the ultraviolet-transmissive conduit comprises quartz. In some embodiments, the ultraviolet-transmissive conduit comprises an anti-corrosive inner surface. In some embodiments, at least 80% of a volume of the ultraviolet-transmissive conduit is irradiated by the ultraviolet light sources.

In some embodiments, an apparatus of the present invention is for treatment of water contained within an ultraviolet-transmissive conduit. In some embodiments, the ultraviolet light sources generate oxygen radicals.

In some embodiments, an apparatus of the present invention comprises a wiper suitable for traversing at least a portion of the ultraviolet-transmissive conduit. In some embodiments, the wiper includes a contact surface suitable for mechanically cleaning an inner surface of the ultraviolet-transmissive conduit. In some embodiments, the wiper comprises a rigid member suitable for controlling the position of the wiper within the ultraviolet-transmissive conduit, wherein the wiper is connected to the rigid member by one or more spokes.

In some embodiments, the mixing system is located at least partially in the ultraviolet-transmissive conduit. In some embodiments, the mixing system comprises an angular feed and at least one mixing device. In some embodiments, the angular feed is attached to the ultraviolet-transmissive conduit such that a fluid flowing into the ultraviolet-transmissive conduit undergoes rotational mixing. In some embodiments, the angular feed comprises an inlet having a first diameter and an outlet having a second diameter, wherein the second diameter is greater than the first diameter.

In some embodiments, the mixing device is at a fixed position within the ultraviolet-transmissive conduit. In some embodiments, the mixing device comprises one or more fixed or rotating fins, baffles, or a combination thereof.

In some embodiments, an apparatus of the present invention comprises a flow diffuser located before the angular feed such that a fluid flowed through the flow diffuser into the angular feed is a fully developed flow. In some embodiments, the flow diffuser induces a pressure drop in a flowing fluid of 10 kPa or less.

The present invention is also directed to a method of treating a fluid, the method comprising directing a flowing fluid through the ultraviolet-transmissive conduit of an apparatus of the present invention, and generating ultraviolet light using the ultraviolet light sources, wherein substantially all of the fluid flowing through the ultraviolet-transmissive conduit is irradiated by the ultraviolet light.

In some embodiments, the ultraviolet-transmissive conduit has a substantially circular cross-section of 25 mm to 75 mm in diameter, and the first and second ultraviolet light sources provide a total dosage of 5 mJ/cm² to 75 mJ/cm² to the fluid flowing through the ultraviolet-transmissive conduit. In some embodiments, a fluid enters the ultraviolet-transmissive conduit at a rate of 100 gallons per minute or less. In some embodiments, a fluid entering the ultraviolet-transmissive conduit has an ultraviolet transmission of at least 60%.

In some embodiments, the ultraviolet-transmissive conduit has a substantially circular cross-section of 60 mm to 125 mm in diameter, and the ultraviolet light sources provide a total dosage of 50 mJ/cm² to 250 mJ/cm² to the fluid flowing through the ultraviolet-transmissive conduit. In some embodiments, a flowing fluid enters the ultraviolet-transmissive conduit at a rate of 25 gallons per minute or more. In some embodiments, a fluid entering the ultraviolet-transmissive conduit has an ultraviolet transmission of 90% or less.

In some embodiments, an apparatus of the present invention comprises a flow diffuser located before the angular feed such that a fluid flowed through the flow diffuser into the angular feed is a fully developed flow. In some embodiments, the flow diffuser induces a pressure drop in a flowing fluid of 10 kPa or less.

The present invention is also directed to an apparatus for the treatment of a fluid, comprising: a cylindrical chamber that includes a reflective inner surface, wherein the cylindrical chamber has an elliptical cross-section; an ultraviolet-transmissive conduit suitable for transmitting a fluid, traversing a length of the cylindrical chamber; an angular feed attached to the ultraviolet-transmissive conduit, wherein the angular feed comprises an inlet having a first diameter and an outlet having a second diameter, wherein the second diameter is greater than the first diameter; one or more ultraviolet light sources positioned within the cylindrical chamber, wherein the ultraviolet light sources provide a non-uniform irradiance of the ultraviolet-transmissive conduit, and wherein substantially all of a fluid flowed through the ultraviolet-transmissive conduit is irradiated by ultraviolet light

Methods of cleaning at least an inner surface of UV transmissive conduit are also provided.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1A provides a three-dimensional cross-sectional representation of an apparatus of the present invention.

FIG. 1B provides a cross-sectional representation of the apparatus of FIG. 1A.

FIG. 1C provides a cross-sectional graphic representation of the distribution of light irradiation within the apparatus of FIG. 1A determined using a modeling simulation.

FIG. 2A provides a schematic representation of selected dimensions for an ellipse, as used to describe an apparatus of the present invention.

FIG. 2B provides a schematic representation of an ellipse having a low eccentricity.

FIG. 2C provides a schematic representation of selected dimensions for an ellipse plotted using a Cartesian coordinate system.

FIG. 3A provides a diagram of an elliptical chamber used in modeling simulations.

FIGS. 3B-3E provide plots of light intensity versus the cross-sectional position within the ultraviolet-transmissive conduit, as determined by modeling simulation for an elliptical chamber, and demonstrate the effect of the diameter of the UV light source on irradiation intensity.

FIGS. 4A-4D provide plots of light intensity versus the cross-sectional position within the ultraviolet-transmissive conduit, as determined by modeling simulation for an elliptical chamber, and demonstrate the effect of moving the UV light source away from one of the foci within an elliptical chamber.

FIGS. 5A-5B provide plots of light intensity versus the cross-sectional position within the ultraviolet-transmissive conduit, as determined by modeling simulation for an elliptical chamber, and demonstrate the effect of changing the eccentricity of an elliptical chamber.

FIG. 6 provides a three-dimensional cross-sectional representation of an apparatus of the present invention.

FIGS. 7A-7C provide graphic representations of results of fluid flow modeling within a portion of an apparatus of the present invention.

FIG. 8 provide a graphic representation of results of thermal profile modeling within a portion of an apparatus of the present invention.

FIGS. 9A-9B provide flow charts for methods of treating a liquid in accordance with embodiments of the present invention.

FIG. 10A provides a three-dimensional cross-sectional representation of an apparatus of the present invention.

FIG. 10B provides a cross-sectional representation of the apparatus of FIG. 10A.

FIG. 11 provides a three-dimensional plot of light intensity versus y- and z-coordinates within the apparatus of FIGS. 10A and 10B determined using a modeling simulation.

FIGS. 12A-12B provide graphic representation of the results of dosage and residence time modeling.

FIG. 13A provides a top-view schematic of an apparatus of the present invention indicating the angle of entry as an adjustable variable.

FIGS. 13B-13C provide graphic representations of the effects of variations in the angle of entry on the irradiation dose of a fluid flowing in an apparatus of the present invention as determined by modeling simulations.

FIGS. 14A-14C provide graphic representations of the UV light dosage versus the radial position within the ultraviolet-transmissive conduit, for conduits of varying diameter, as determined by modeling simulations.

FIG. 15 provides a cross-sectional side-view of an ultraviolet-transmissive conduit that includes a system for cleaning the ultraviolet-transmissive conduit.

FIG. 16 is a cross-sectional end-view of a system for cleaning an ultraviolet-transmissive conduit of FIG. 15.

FIG. 17 provides a three-dimensional schematic diagram of an apparatus of the present invention comprising a wiper suitable for traversing at least a portion of an inner surface of an ultraviolet-transmissive conduit.

FIGS. 18A-18B provide cross-sectional schematic representations of an apparatus of the present invention.

FIG. 19 provides a graphic representation of the distribution of light irradiation within the apparatus of FIG. 18B determined using a modeling simulation.

FIG. 20 provides a three-dimensional cross-sectional representation of an apparatus of the present invention.

FIGS. 21A-21B provide graphic representations of the distribution of light irradiation within apparatus of FIG. 20 determined using modeling simulations.

FIGS. 22A-22B provide schematic representations of flow diffusers for use with the present invention.

FIG. 23A provides a schematic cross-sectional diagram of an apparatus of the present invention.

FIG. 23B provides a graphic representation of the distribution of light irradiation within apparatus of FIG. 23A determined using a model simulation.

FIGS. 24A-24B provide schematic cross-sectional diagrams of an apparatus of the present invention.

FIG. 25A provides a cross-sectional representation of an angular feed of the present invention.

FIG. 25B provides a cross-sectional side view of a portion of an apparatus of the present invention.

FIG. 26 provides a graphic representation of result of fluid flow modeling within a portion of an apparatus of the present invention.

FIGS. 27A-B provide cross-sectional representations of a portion of an apparatus of the present invention.

FIG. 28 shows a photograph of a prototype mixing device.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “some embodiments,” “one embodiment,” “an embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

### Apparatus and Methods of Use

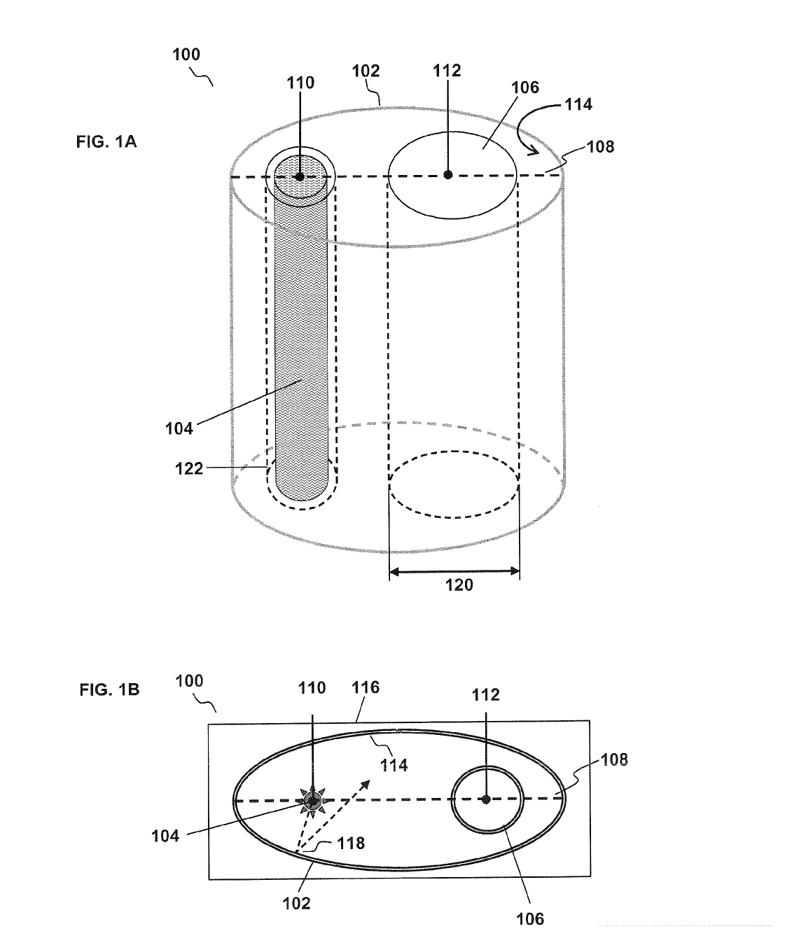

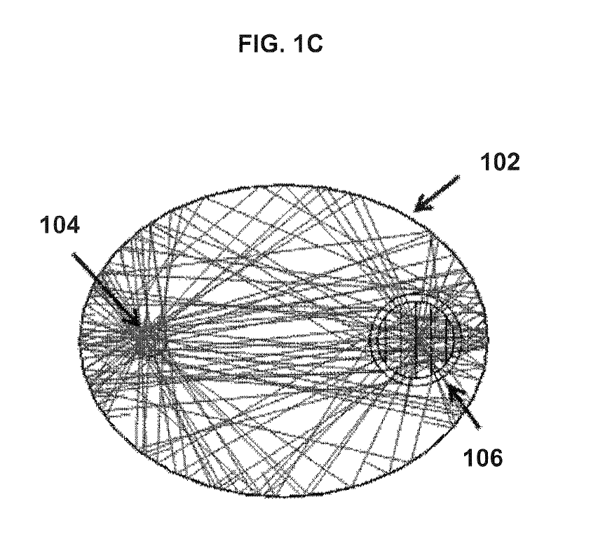

In one embodiment, the present invention provides apparatuses for the treatment of a fluid, including water (e.g., drinking water, municipal waste water, industrial waste water, sewer water, storm water, etc.). Additional fluids that can be treated include polymeric fluids (e.g., ultraviolet light-curable polymers, and the like), gases, etc. As shown in FIGS. 1A-1B, an apparatus 100 suitably comprises a cylindrical chamber 102 having an elliptical cross-section and a reflective inner surface 114.

As used herein, a “cylindrical chamber” refers to a structure having a tubular shape with a length, and a substantially uniform cross-section throughout the length. It should be noted that a cylindrical chamber, while suitably having an elliptical cross-section, when present in an apparatus of the present invention can be positioned within a structure or enclosure of arbitrary shape (i.e., any shape). For example, referring to FIG. 1B, chamber 102 can be placed in a rectangular or other shaped structure, 116. An outer structure or enclosure can be decorative, can add to the structural integrity of the apparatus, and/or can permit facile integration with other components and devices.

A cylindrical chamber suitably includes a reflective inner surface. Referring to FIG. 1B, a reflective inner surface, 114, provides for internal reflection of light, 118, within the cylindrical chamber.

As used herein “reflective” refers to a surface having a reflectivity of 50% or more, such that the intensity of a light impinging upon a reflective inner surface is diminished by 50% or less by reflection from the inner surface (i.e., losses from absorption, transmission, and other processes total 50% or less of the total intensity of the incoming light). In some embodiments, at least 75%, at least 80%, at least 85%, at least 90%, at least 95%, at least 97%, at least 99%, or 100% of the area of the inner surface of a cylindrical chamber is reflective. An inner surface of a cylindrical chamber can be prepared using an inherently reflective material, can be polished to provide a reflective surface, or can be covered with a reflective material. In some embodiments, an inner surface, 114, is made reflective by affixing, adhering, or otherwise covering an inner surface of the cylindrical chamber with a reflective material.

Reflective materials suitable for use with the present invention include any material that reflects at least 50% of ultraviolet light having a wavelength of about 250 nm to about 400 nm. Suitably, a reflective material reflects at least 60%, at least 70%, at least 80%, at least 90%, at least 95%, at least 99%, at least 99.9%, or about 100% of ultraviolet light having a wavelength of about 250 nm to about 400 nm that impinges upon an inner surface. Exemplary reflective materials include plastics, polymers, glasses, metals, ceramics, composites, etc. Reflective materials suitable for use with the present invention include, but are not limited to, metals (e.g., aluminum, chromium, gold, silver, tungsten, tin, titanium, and the like, oxides thereof, and alloys thereof), ceramics and glasses (e.g., carbides, nitrides, oxycarbides, oxynitrides, carboxynitrides, borocarbides, boronitrides, borophosphides, and the like, and combinations thereof), and the like. In some embodiments, the reflective surface comprises polished aluminum.

Suitably, reflective material comprises a metal such as Al, or glass, and is suitably polished to increase its reflectivity. In suitable embodiments the ends of chamber are also suitably covered or capped with a reflective material, such as a metal or glass, including Al mirrors and the like. The ends are suitably positioned perpendicular to the axis of chamber.

A reflective material can be coated, layered, deposited, formed, sprayed, or otherwise disposed on an inner surface of a cylindrical chamber, or chamber can be prepared from a reflective material. In some embodiments, a reflective inner surface of a chamber is treated with an antibacterial coating, for example a Ag or Cu coating, and/or an anti-corrosive coating to minimize corrosion, including chemical, particle and bacterial deposits. Additional coatings or treatments include non-stick and anti-fouling coatings and treatments. Examples of include chemical surface treatments, such as spraying, dipping, coating, layering, painting, etc., with a chemical compound, as well as physical treatments, including roughening, etc., to make the inner surface anti-corrosive.

In further embodiments, an additional reflector, for example a flat or substantially flat panel (not shown) can be included in the cylindrical chamber opposite the ultraviolet light source, i.e., on a far side of the ultraviolet-transmissive conduit away from a light source. Additional components can also be included within a cylindrical chamber to aid in maintaining the temperature of a fluid flowed through the ultraviolet-transmissive conduit. Such components can include fans or air-vents, as well as tubing to circulate cooled liquid. Sensors can also be included within or around the cylindrical chamber that provide data on the power output of the UV light source in real time, as well as the temperature within the chamber and/or of the fluid.

Referring to FIGS. 1A and 1B, apparatus 100 suitably comprises an ultraviolet (UV) light source 104 contained within cylindrical chamber 102. UV light source 104 is suitably located at a first focal point 110, on a major axis, 108, of the elliptical cross-section.

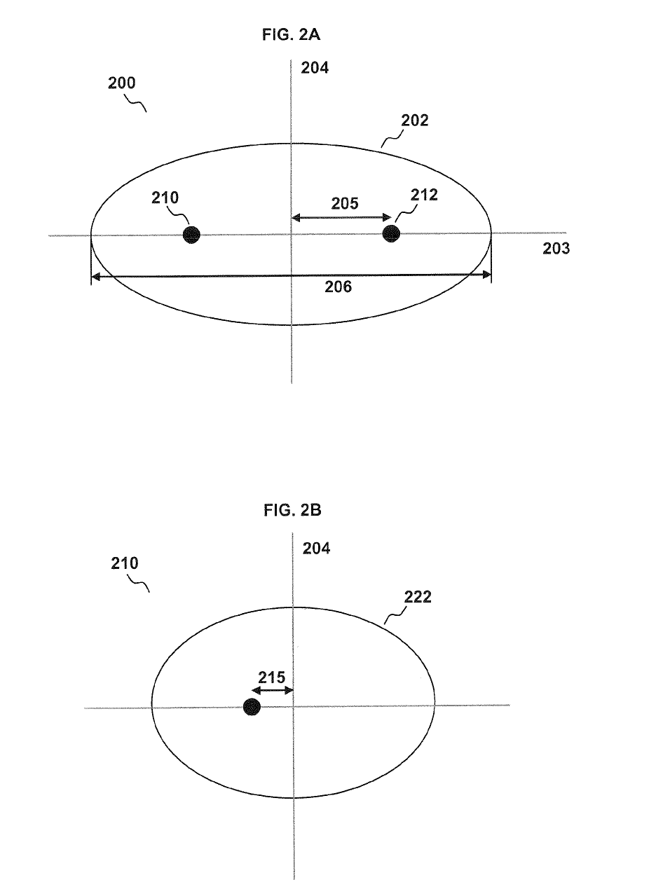

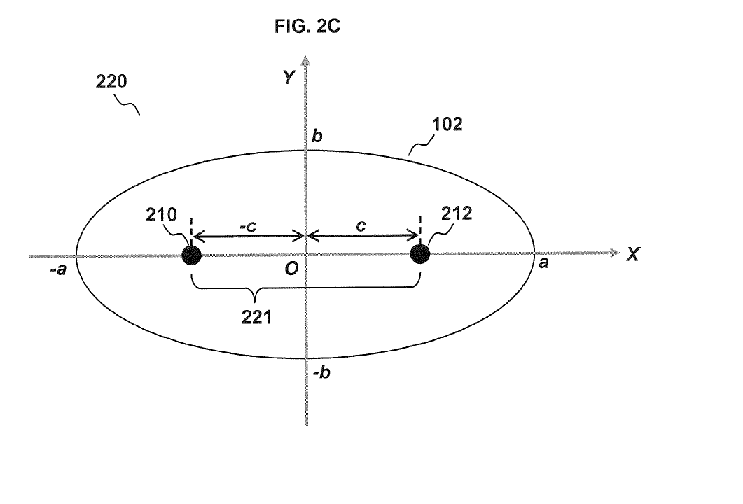

FIG. 2A provides an exemplary schematic diagram, 200, of an ellipse. An ellipse is a symmetric closed curve, 202, having a major axis, 203, and a minor axis, 204. The ellipse comprises a first focal point, 210, and a second focal point, 212, located on the major axis, 203, and the ellipse, 202, is a locus of points such that the sum of the distances from any point of the ellipse, 202, to the first and second focal points, 210 and 212, is constant and equal to the major diameter, 206.

FIG. 2C provides a schematic representation of selected dimensions for an ellipse plotted using a Cartesian coordinate system. Referring to FIG. 2C, the equation for an ellipse is:

$$\frac{{x}^{2}}{{a}^{2}} + \frac{{y}^{2}}{{b}^{2}} = 1 , \qquad ( 1 )$$

wherein the origin of coordinates is the center of geometric symmetry of the ellipse, and the coordinate axes are its axes of symmetry (i.e., the ellipse is symmetrical around the X and Y axes, see FIG. 2C). As shown in FIG. 2C, distances “a,” “−a,” “b,” and “−b,” represent the edges of the ellipse, and thus correspond to the overall dimensions of an elliptical cross section (i.e., describing a cylindrical chamber). When a>b, foci of the ellipse (210 and 212) are on the axis OX (FIG. 2C), and when a<b, the foci of the ellipse are on small axis OY. The distance between the focal points 210 and 212, is 2c, where c and −c is the focal length (i.e., the distance from the origin, 0, to the focal points, 212 and 210, respectively. The eccentricity (e) of an ellipse (as shown in FIG. 2C) is represented by e=c/a, with e<1 for all values of c and a.

In exemplary embodiments, an elliptical cross-section of a cylindrical chamber has an eccentricity of 0 to 0.5, suitably 0 to 0.4, 0 to 0.3, 0 to 0.2, 0 to 0.1, and more suitably, about 0.20, about 0.21, about 0.22, about 0.23, about 0.24, about 0.25 about 0.26, about 0.2, about 0.28, about 0.29 or about 0.30. Referring to FIGS. 2A and 2B, differences in overall shape between a “low eccentricity ellipse” in FIG. 2B (eccentricity of less than 0.5) and a “high eccentricity ellipse,” FIG. 2A (eccentricity of 0.5 to 1) are provided.

Referring to FIGS. 1A and 1B, apparatus 100 comprises an ultraviolet-transmissive conduit 106 traversing the length of chamber 102. Suitably, ultraviolet-transmissive conduit 106 is located at a second focal point 112 of the elliptical cross-section. As used herein, “ultraviolet-transmissive conduit” refers to a tube, reservoir, or channel that is substantially permeable to UV light, i.e., at least 75%, at least 80%, at least 85%, at least 90%, at least 95%, or about 99% of the UV light impinging upon an outer surface of the ultraviolet-transmissive conduit is transmitted through the ultraviolet-transmissive conduit to its interior. Measurement of the permeability of the ultraviolet-transmissive conduit can be made using any suitable method, for example, an ultraviolet light meter placed within the ultraviolet-transmissive conduit capable of measuring the amount of UV light that passes through the ultraviolet-transmissive conduit as compared to the UV light that strikes the ultraviolet-transmissive conduit. Ultraviolet-transmissive conduit 106 suitably provides a mechanism for containing a fluid so that the fluid is irradiated by the UV light produced by UV light source 104. Transmissive conduit 106 comprises any suitable material that retains fluid (e.g., water), but is also transmissive to UV light. Exemplary materials for transmissive conduit 106 include glasses, polymers, composites, etc. In suitable embodiments, transmissive conduit 106 comprises quartz.

Ultraviolet-transmissive conduit 106 comprises an inlet and outlet that allow for introduction of fluid 108 into the ultraviolet-transmissive conduit, so as to flow a fluid through chamber 102. Suitable inlet and outlet connectors are known in the art, and include liquid-tight connectors that allow fluid flow without leakage. Thus, in suitable embodiments, apparatus 100 can be removed from a larger device and interchanged with another apparatus 100.

In some embodiments, the ultraviolet-transmissive conduit comprises an inlet and outlet that allow a fluid enters and exits at different ends of a chamber. In some embodiments, the ultraviolet-transmissive conduit comprises an inlet and outlet that allow a fluid enters and exits at the same end of a chamber. In some embodiments, the ultraviolet-transmissive conduit has a U shape. In some embodiments, the ultraviolet-transmissive conduit has an H-shape.

Referring to FIG. 1A, suitably, the ultraviolet-transmissive conduit 106 has a substantially circular cross-section having a diameter, 120, of 10 mm to 125 mm, 10 mm to 100 mm, 10 mm to 75 mm, 10 mm to 50 mm, 20 mm to 125 mm, 20 mm to 100 mm, 20 mm to 75 mm, 30 mm to 100 mm, 30 mm to 75 mm, 40 mm to 90 mm, 40 mm to 80 mm, 50 mm to 80 mm, or 50 mm to 75 mm. As used herein, “substantially circular” includes cross-sections that are oval, elliptical, circular, etc., in cross-section. Other shaped cross sections, such as triangular, square, rectangular, as well as irregular cross-sections, can also be utilized.

An ultraviolet-transmissive conduit can have a length of 10 cm to 300 cm, 10 cm to 250 cm, 10 cm to 200 cm, 10 cm to 175 cm, 10 cm to 150 cm, 10 cm to 125 cm, 10 cm to 100 cm, 20 cm to 300 cm, 20 cm to 250 cm, 20 cm to 200 cm, 20 cm to 150 cm, 20 cm to 100 cm, 30 cm to 300 cm, 30 cm to 250 cm, 30 cm to 200 cm, or 30 cm to 150 cm. It should be noted that other dimensions of transmissive conduit can also be utilized, including longer or shorter conduits, or conduits with larger or smaller diameters.

Methods for optimizing the diameter of ultraviolet-transmissive conduit include the use of irradiance mapping and curve fitting. An irradiance map of a transmissive conduit can be either determined experimentally or estimated via simulation and modeling. A Gaussian function can then be curve-fitted to the cross-section of the irradiance map, for example, using a least squares fitting. The standard deviation, σ, of the Gaussian profile is then used to determine the optimal diameter of the ultraviolet-transmissive conduit, suitably 2√2σ to 4√2σ. See Example 1.

As shown in FIGS. 1A and 1B, UV light source 104 and transmissive conduit 106 are positioned at focal points 110 and 112, such that the center of light source 104 and the center of conduit 106 coincide with the focal points. While light source 104 is shown spanning the entire length of chamber 102, in further embodiments, light source 104 can span a portion of the length, suitably 10% to 100% of the total length.

FIG. 1C provides a cross-sectional graphic representation of the distribution of light irradiation within the apparatus of FIG. 1A determined using a modeling simulation. Referring to FIG. 1C, the positioning of light source 104 and conduit 106 within chamber 102, and selection of appropriate characteristics of the light source (such as size and power), as well as eccentricity of the ellipse, provide for irradiation of conduit 106. When a fluid is flowed through conduit 106 a fluid undergoes rotational mixing, and as a result substantially all of a fluid within the ultraviolet-transmissive conduit is irradiated despite a non-uniform irradiance of the conduit by the ultraviolet light sources.

As used herein, “substantially all” when referring to the irradiation of a fluid flowing within transmissive conduit 106 indicates that greater than 50%, greater than 60%, greater than 70%, greater than 75%, greater than 80%, greater than 85%, greater than 90%, greater than 95%, or about 100% of the fluid flowing through the cross-section is irradiated.

Referring to FIG. 1C, the distribution of light impinging upon ultraviolet-transmissive conduit 106, has a non-uniform distribution on the outer surface of the ultraviolet-transmissive conduit. Thus, the ultraviolet light source, 104, provides a non-uniform irradiance of the ultraviolet-transmissive conduit, 106. Nonetheless, the apparatus of the present invention irradiates substantially all of a fluid that is flowed through the ultraviolet-transmissive conduit.

In some embodiments, an ultraviolet-transmissive conduit comprises a mixing system to assist in mixing a fluid that is flowed through the apparatus so as to expose more of the fluid to UV light and/or to uniformly expose a flowing fluid to UV light. Mixing systems suitable for use with the present invention include, but are not limited to, an angular feed, a mixing device, and combinations thereof.

In some embodiments, an apparatus of the present invention comprises an angular feed attached to the ultraviolet-transmissive conduit such that a fluid flowed into the ultraviolet-transmissive conduit undergoes rotational mixing. Not being bound by any particular theory, mixing of the fluid within the ultraviolet-transmissive conduit provides that substantially all of the flowing fluid is irradiated despite non-uniform irradiance of the ultraviolet-transmissive conduit.

In some embodiments, an ultraviolet-transmissive conduit comprises a scraper to assist with cleaning the ultraviolet-transmissive conduit and remove deposits from an interior surface thereof, such as mineral deposits, bacteria, and the like that can form on an inner surface of the ultraviolet-transmissive conduit.

Referring to FIG. 2A, a high eccentricity ellipse, 202, has a focal length, 205, the magnitude of which is the distance from the minor axis, 204, to focal points 210 and 212. As used herein, a “major axis” refers to the axis of the ellipse having the larger length dimension, as compared to a “minor axis.” In suitable embodiments, an elliptical cross-section of a cylindrical chamber of the present invention has a focal length of 10 mm to 50 mm, suitably, 20 mm to 50 mm, 20 mm to 40 mm, 30 mm to 40 mm, 35 mm to 40 mm, about 30 mm, about 35 mm, or about 40 mm.

Referring to FIG. 2B, a low eccentricity ellipse, 222, having focal length 215 is represented. Suitably, a low eccentricity ellipse for use with the present invention has a major axis length (from end to end of the ellipse along the major axis) of 80 mm to 300 mm, 80 mm to 200 mm, 100 mm to 200 mm, suitably 110 mm to 180 mm, 110 mm to 170 mm, 110 mm to 160 mm, 120 mm to 150 mm, 125 mm to 145 mm, suitably about 125 mm, about 130 mm, about 140 mm or about 145 mm. In exemplary embodiments, the dimension of a low eccentricity ellipse for use in the practice of the present invention along the minor axis 204 is 80 mm to 300 mm, 100 mm to 200 mm, suitably 110 mm to 180 mm, 110 mm to 170 mm, 110 cm to 160 mm, 120 mm to 150 mm, 120 mm to 140 mm, suitably about 120 mm, about 125 mm, 130 mm, 135 mm, or about 140 mm. It should be noted that larger or smaller focal lengths can also be used. In addition, the size of a cylindrical chamber can be readily scaled, while still maintaining the ratio of dimensions of the major and minor axes of 1.036 to 1.042 (major:minor).

Ultraviolet light source 104, suitably is a UV lamp or bulb having a diameter of 5 mm to 70 mm, more suitably 10 mm to 50 nm, 10 mm to 40 mm, 15 mm to 40 mm, 20 mm to 40 mm, 20 mm to 30 mm, or about 10 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, about 25 mm, about 26 mm, about 27 mm, about 28 mm, about 29 mm, or about 30 mm in diameter. The diameter of ultraviolet light source 104 is measured across the largest cross-section of the ultraviolet light source. Length of UV light source 104 can be the full length of chamber 102, or can be shorter. Suitably UV light source is 10 cm to 200 cm in length. In exemplary embodiments, UV light source is a PHILLIPS® TUV (Xtra) 55 Watt bulb with a HF ballast power supply, available from Radiant Source Technologies, San Jose, Calif. (part numbers 4012550/V0068 and 6012550/V0068). Suitable ultraviolet light sources can also be obtained from, for example, Ushio America, Inc., Cypress, Calif.

UV light source suitably generates light at a wavelength of 10 nm to 400 nm. Suitably, UV light generated by UV light source is UV-C, or short wave UV light, with a wavelength (λ) of 100-280 nm, suitably about 254 nm. UV-A, or long wave UV light (λ=320-400 nm), as well as UV-B, or medium wave UV light (λ=280-320 nm), can also be utilized. In further embodiments, a cylindrical chamber can comprise additional ultraviolet light sources (e.g., additional UV lamps), to maximize the irradiation of a flowing fluid in the ultraviolet-transmissive conduit. Suitably UV light source can generate UV light that serves to reduce or kill bacteria in a fluid (e.g., water), for example, light at about 254 nm, and can also generate UV light which generates oxygen radicals, for example, light at about 185 nm. The shorter UV light at about 185 nm generates oxygen radicals (e.g., ozone) within an aqueous fluid that is flowed into the apparatus, which in turn oxidizes organic molecules that are present in the aqueous fluid.

In other embodiments, a diffuser, lens, or other optical element can be placed between an ultraviolet light source and an ultraviolet-transmissive conduit to control the intensity or amount of irradiation of a fluid flowed into the apparatus. Referring to FIG. 1A, in exemplary embodiments, an ultraviolet-transmissive sheath 122 surrounds ultraviolet light source 104. Ultraviolet-transmissive sheath refers to a cover, tube, encapsulant or other casing which surrounds, or at least partially surrounds, UV light source, and suitably surrounds the entire length of UV light source 104. Suitably, ultraviolet-transmissive sheath comprises a glass, a polymer, or other material. Suitably the sheath is quartz and is on the order of 10's of microns, to a few millimeters, to 10's of millimeters, in thickness. The shape of ultraviolet-transmissive sheath 120 can take any form that encloses UV light source, including cylindrical shapes with circular, elliptical, rectangular, square, or other cross-sections. Ultraviolet-transmissive sheath can directly contact the outer surface of UV light source, or can be spaced a few millimeters, to 10's of millimeters (e.g., 5 mm to 50 mm) from the surface of UV light source. Suitably, the center of ultraviolet-transmissive sheath is centered on the focal point 110 of the ellipse, though in other embodiments, can be placed off-center with regard to the focal point. Ultraviolet-transmissive sheath suitably serves to reduce heat radiating from the UV light source and also can serve as a lens to either diffract or focus the UV light.

In further embodiments, the present invention provides additional apparatus for the treatment of a fluid. In exemplary embodiments, as represented in FIGS. 1A-1B, the apparatus 100 suitably comprises a cylindrical chamber 102 having a elliptical cross-section and a reflective inner surface 114. An ultraviolet light source 104 having a diameter greater than 30 mm is contained within chamber 102, located at a first focal point 110 of the elliptical cross-section. As shown in FIGS. 1A and 1B, apparatus 100 suitably comprises an ultraviolet-transmissive conduit 106 traversing a length of the chamber 102 and located at a second focal point 112 of the elliptical cross-section. Suitably, the elliptical cross-section has an eccentricity of 0 to 0.5, wherein the ultraviolet light source provides a non-uniform irradiance of the ultraviolet-transmissive conduit, and wherein substantially all of a fluid flowed through the ultraviolet-transmissive conduit is irradiated by ultraviolet light.

Exemplary dimensions, characteristics, and materials, for the components of apparatus 100 are described herein. In suitable embodiments, the elliptical cross-section has a focal length of 20 mm to 40 mm (e.g., 35 mm to 40 mm). Suitably, reflective material 118 comprises Al, and the ultraviolet-transmissive conduit 106 comprises quartz. Ultraviolet-transmissive conduit 106 suitably has a substantially circular cross-section 120 of 50 mm to 75 mm in diameter, and a length of 20 cm to 175 cm, and can be treated with an anti-corrosive coating. Suitably at least 80% (e.g., at least 90%, at least 95% or at least 99%) of the transmissive conduit, and thus the fluid within the ultraviolet-transmissive conduit, is irradiated by the ultraviolet light source.

The dimensions of chamber 102, ultraviolet light source 104, conduit 106, as well as the relationship between the components of the apparatus of the present invention, can readily be scaled in increasing or decreasing amounts to accommodate larger or smaller fluid volumes as desired. For example, the apparatus of the present invention is readily scalable to accommodate flow rates within conduit 106 on the order of 0.01 to thousands of gallons per minute, or more (0.01 to 1,000+ gallons/min). The ability to scale the dimensions of the apparatus of the present invention is well within the skill of one in the art.

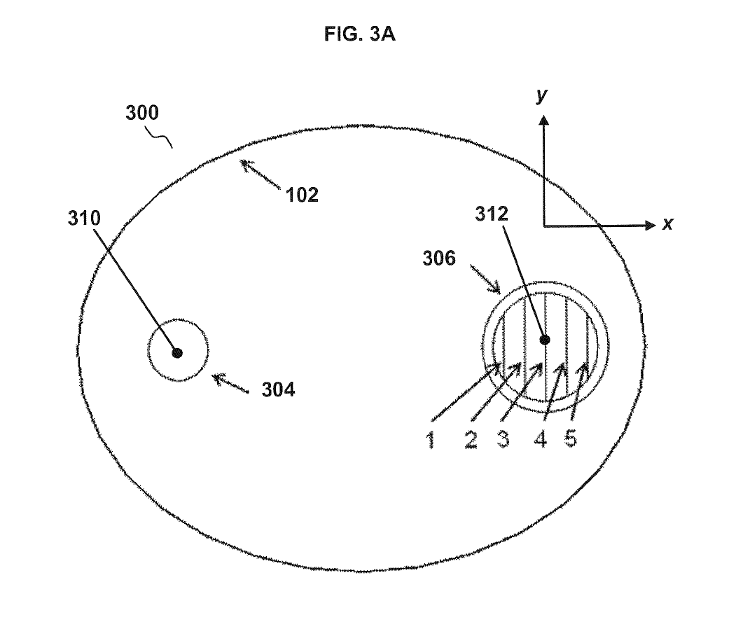

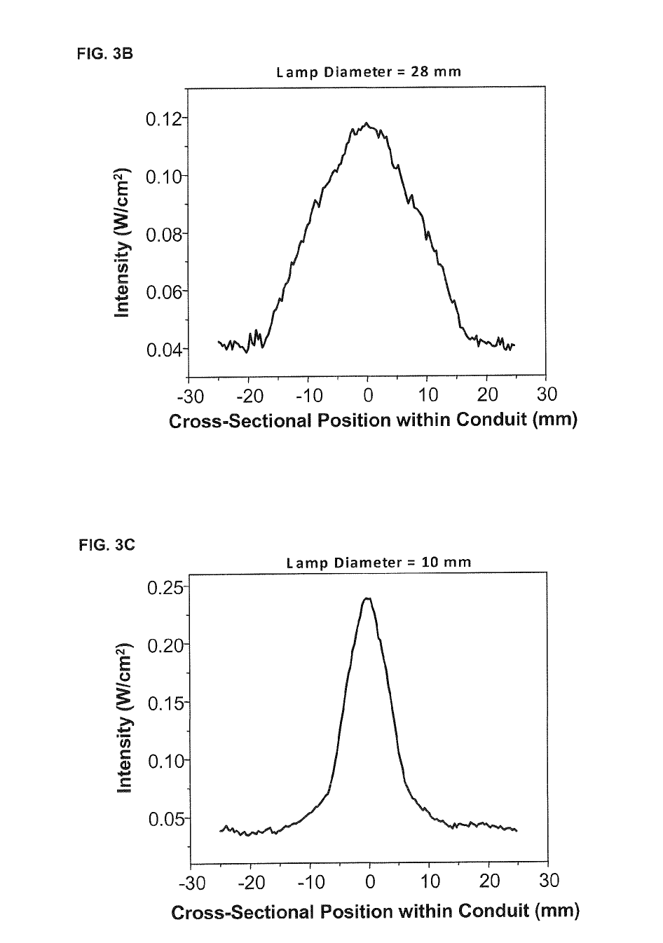

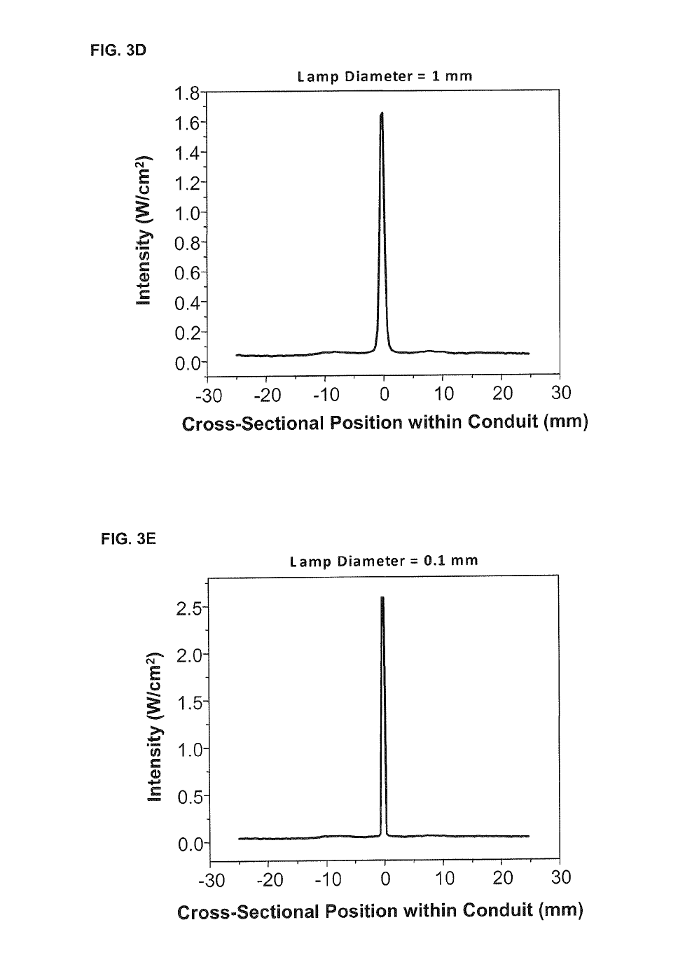

FIG. 3A provides a diagram of an elliptical chamber used in modeling simulations. Variables included in the modeling simulations include the position of the ultraviolet light source and eccentricity of the ellipse, and effects of these parameters on power transfer to a fluid flowed through the ultraviolet-transmissive conduit. Referring to FIG. 3A, apparatus 300 comprises a cylindrical chamber 102 having an elliptical cross section, an ultraviolet light source 304, positioned at a first focal point, 310, and an ultraviolet-transmissive conduit, 306, positioned at a second focal point, 312. To estimate the irradiation of a fluid flowing through the ultraviolet-transmissive conduit, 306, the inner portion of conduit was segmented into five (5) positions, noted by vertical lines 1, 2, 3, 4, and 5. Vertical lines (1, 2, 3, 4, and 5) represent positions of five sensors within the ultraviolet-transmissive conduit, 306, for which irradiation is modeled in various figures described below.

FIGS. 3B-3E provide plots of light intensity versus the cross-sectional position within the ultraviolet-transmissive conduit, and demonstrate the effect of the diameter of the UV light source on irradiation intensity, as determined by modeling simulations for the apparatus of FIG. 3A. The elliptical cross-section utilized in the modeling simulations had the following dimensions: a major axis of 136 mm, a minor axis of 103 mm, a focal length of 88.8 mm, and an eccentricity of 0.65. The ultraviolet-transmissive conduit had a diameter of 50 mm. The UV light source was a 55 W high output lamp from Philips. Light intensity was determined as a function of displacement along the x-axis from the center of the ultraviolet-transmissive conduit. The distance across the ultraviolet-transmissive conduit is represented on the x-axis of FIGS. 3B-3E, with the center positioned at “0” and the diameter of the ultraviolet-transmissive conduit represented as ±25 mm on either side of the center of the ultraviolet-transmissive conduit. Referring to FIG. 3A, vertical line 3 was the center of the ultraviolet-transmissive conduit or zero, vertical lines 2 and 4 were −10 mm and +10 mm from the center of the ultraviolet-transmissive conduit, respectively, and vertical lines 1 and 5 were −20 mm and +20 mm from the center of the ultraviolet-transmissive conduit, respectively. The transmittance of the fluid was 70-98%. The reflectivity of the elliptical surface was 80-99%.

As shown in FIGS. 3C-3E, increasing the diameter of the lamp from 0.1 mm (FIG. 3E), to 1 mm (FIG. 3D), and to 10 mm (FIG. 3C), decreased the peak intensity of the UV light irradiation. However, the breadth of the intensity was increased such that uniform irradiation across the entire diameter of the ultraviolet-transmissive conduit was achieved, providing a wider cross-section of coverage of the UV light. A lamp diameter of 28 mm, shown in FIG. 3B, yields a high level of irradiance (about 60 mW/cm² to about 120 mW/cm²) across nearly the entire cross-section of conduit, as compared to lamps of smaller diameters. As noted above, as a fluid flows through an ultraviolet-transmissive conduit in an apparatus of the present invention, substantially all of the fluid flowing within the ultraviolet-transmissive conduit is irradiated by the UV light source(s).

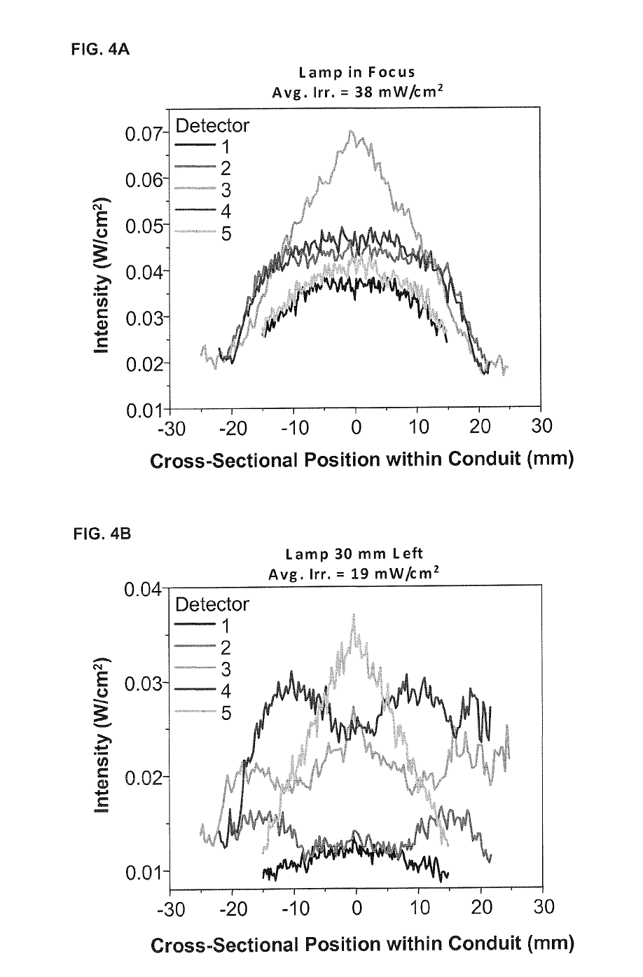

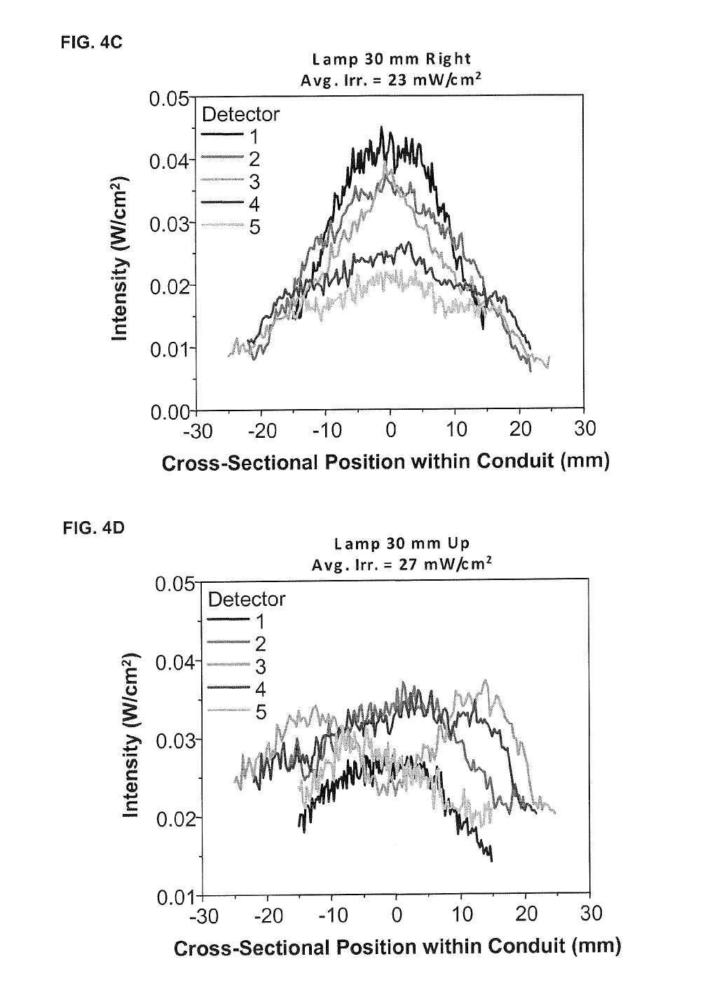

Modeling simulations that examined the effect of moving the ultraviolet light source away from a first focal point were conducted, the results of which are provided graphically in FIGS. 4A-4D. FIGS. 4A-4D provide plots of light intensity versus the cross-sectional position within the ultraviolet-transmissive conduit, as determined by modeling simulations for an elliptical chamber, and demonstrate the effect of moving the UV light source away from one of the foci within an elliptical chamber. FIGS. 4A-4D show the ultraviolet light source-to-transmissive conduit power transfer (i.e., the UV power that is transferred to a fluid within a conduit) in watts per square centimeter (W/cm²) or milliwatts per square centimeter (mW/cm²) as a function of the cross-sectional position within the ultraviolet-transmissive conduit (center of conduit depicted at x=0, width of conduit is 50 mm, represented as ±25 mm on either side of center). The five detector positions within conduit are represented on the graphs, with the center detector (3) receiving the highest intensity of light.

FIG. 4A shows the power transfer when an ultraviolet light source is positioned at a focal point. The average of the five detectors indicates a power transfer of 38 mW/cm². Moving the ultraviolet light source along the major axis off of the focal point and away from the ultraviolet-transmissive conduit (a distance 30 mm), decreases the power output to 19 mW/cm², as represented in FIG. 4B. Moving the ultraviolet light source along the major axis off of the focal point and towards the ultraviolet-transmissive conduit (a distance of 30 mm), also decreased the power transfer to a fluid within the ultraviolet-transmissive conduit to an average of 23 mW/cm², as demonstrated in FIG. 4C. Moving the ultraviolet light source off the major axis while maintaining a constant distance from the minor axis (a distance of 30 mm) decreased the power transfer to a fluid within the ultraviolet-transmissive conduit to 27 mW/cm², as represented in FIG. 4D.

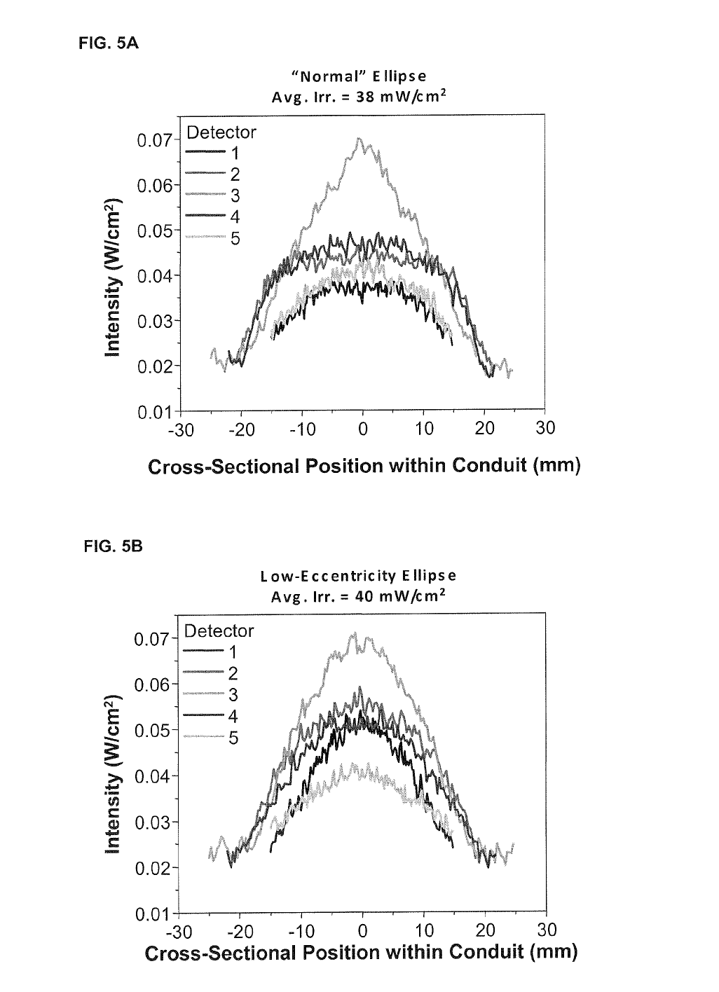

As illustrated in FIGS. 5A-5B, an increase in power transfer from the ultraviolet light source to a fluid within the ultraviolet-transmissive conduit can be achieved by reducing the eccentricity of the elliptical cross-section of the cylindrical chamber.

FIG. 5A shows the results of a simulation examining the power transfer from an ultraviolet light source positioned at a focal point within a chamber having an elliptical cross-section and the following dimensions: a focal length of 88.8 mm, a major axis of 136 mm, a minor axis of 103 mm, and an eccentricity of 0.65. This configuration represents a “normal eccentricity” ellipse (eccentricity of greater than 0.5). The ultraviolet-transmissive conduit was positioned on the second focal point. The UV light source was a 55 W high output lamp from Philips. The results are presented as the power transfer across the diameter (50 mm) of the detector, with the center of the detector positioned at x=0, and the central detector (3) showing the highest irradiation levels. As shown in FIG. 5A, power transfer for this configuration was determined to be 38 mW/cm². In FIG. 5B, a “low eccentricity” ellipse was modeled to determine the effect on power transfer. The cylindrical chamber utilized to generate FIG. 5B had the following dimensions: a major axis of 135 mm, a minor axis of 130 mm, a focal length of 36.4 mm, and an eccentricity of 0.27. As shown in FIG. 5B, reducing the eccentricity of the ellipse increased the power transfer to 40 mW/cm². Thus, a gain in power can be achieved by decreasing the eccentricity of the ellipse (i.e., to an eccentricity of less than 0.5). An increase in power transfer to a fluid within the ultraviolet-transmissive conduit can also be achieved by reducing the distance between the ultraviolet light source and the ultraviolet-transmissive conduit.

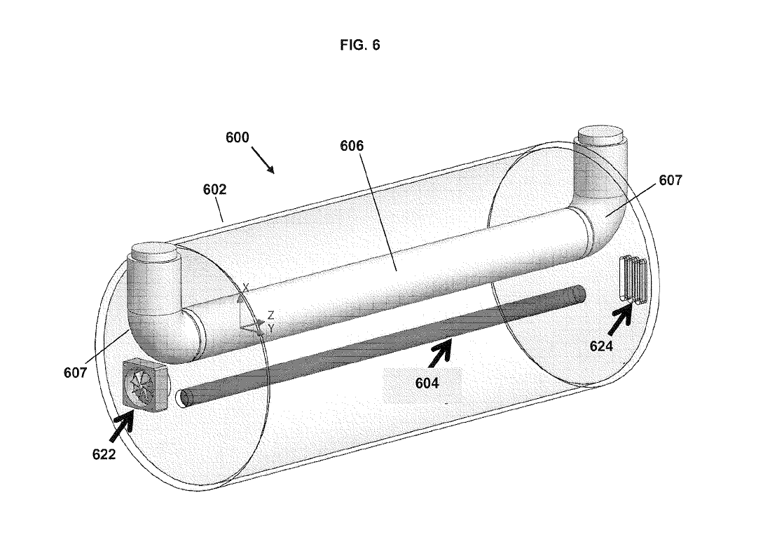

FIG. 6 provides a three-dimensional cross-sectional representation of an apparatus of the present invention. Apparatus 600 comprises chamber 602 having an elliptical cross-section, ultraviolet-transmissive conduit 606 and ultraviolet light source 604. Suitably, as shown, the ends of ultraviolet-transmissive conduit comprise angular feeds 607 suitable for inducing rotational mixing in a fluid flowed into the ultraviolet-transmissive conduit. The angular feeds 607 can be positioned at various angles relative to the axis of the chamber, and suitably are at an angle of 70° to 120° relative to the chamber axis, and more suitably, are right angle (i.e., about 90°) feeds. The angle and orientation of angle feeds 607 can be optimized so as to increase the turbulence, and thus mixing, of the fluid. This includes the orientation of the angle feeds (both inlet and outlet) relative to the chamber as well as to each other (e.g., inlet comes from above the chamber, outlet empties below the chamber), and also includes the number, orientation and complexity of the angle feeds that are used to introduce the fluid into the chamber. The ends of chamber 602 are represented as flat, planar reflective elements, though other configurations and shapes can also be used.

Referring to FIG. 6, also included in apparatus 600 are additional components such as a fan 622 and air vent 624 that help to cool chamber 602 by circulating air through the chamber. Additional components can also be included. It should be noted that apparatus 600 shown in FIG. 6 is provided for illustrative purposes only and other configurations and orientations can be utilized.

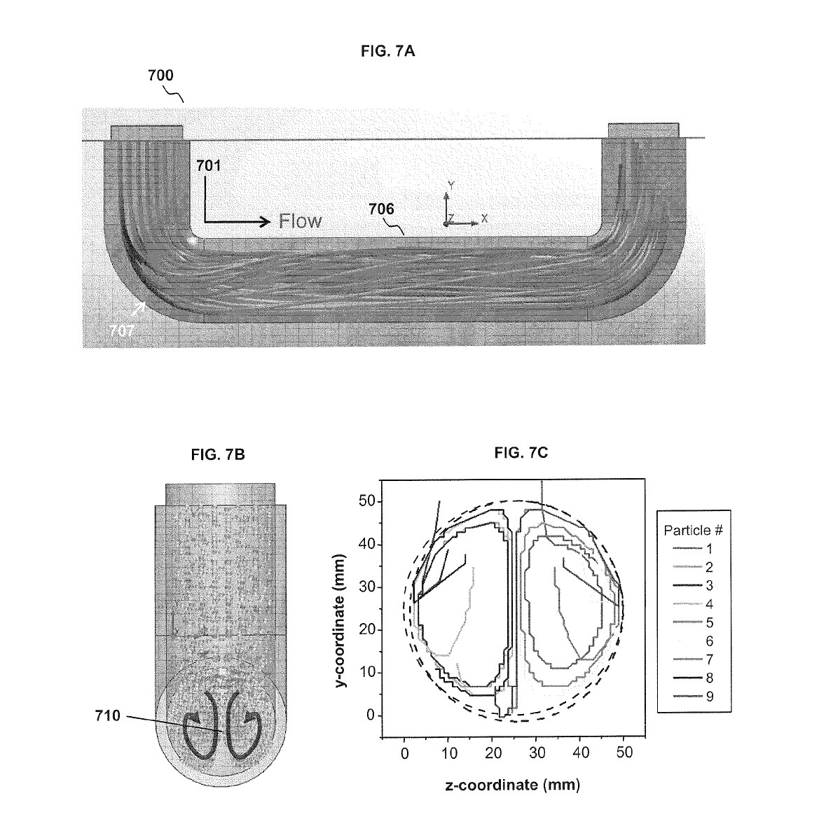

FIG. 7A provides a graphic representation, 700, of the results of fluid flow modeling within a portion of an apparatus of FIG. 6. As shown, the presence of angular feed, 707, induces rotational mixing in a fluid flowing, 701, through the ultraviolet transmissive conduit, 706. The dosage of ultraviolet light provided to a flowing fluid can be determined by the product of irradiance multiplied by its residence time in the chamber. Rotational mixing increases the overall dosage of UV light that is transferred to a fluid flowing through the ultraviolet-transmissive conduit.

FIG. 7B provides a cross-sectional view of mixing within ultraviolet conduit 706 from the right angle feed 707. As demonstrated in FIG. 7C, modeled particles within the fluid suitably complete at least one “cycle” within the ultraviolet-transmissive conduit, passing through the approximate center of the ultraviolet-transmissive conduit, as well as about one-half of the outer circumference.

In some embodiments, a fluid flowing through an angular feed and an ultraviolet-transmissive conduit is fully developed. As used herein, “fully developed flow” refers to a flow through a pipe, conduit, tube, and the like, in which the boundary layer of the fluid that is flowing past the inner surface of the pipe, conduit, tube, and the like has a stabilized velocity. In some embodiments, a fluid having a fully developed flow has a Reynolds Number of 2,000 or greater, 2,100 or greater, 2,200 or greater, 2,300 or greater, 2,500 or greater, 3,000 or greater, 4,000 or greater, 5,000 or greater, or 10,000 or greater.

Not being bound by any particular theory, a flow of a fluid can become fully developed upon entering a pipe, conduit, tube, and the like after traveling through the pipe a distance of several diameters. The distance that a flowing fluid travels through a pipe, conduit, tube, and the like, can be decreased by introducing a flow diffuser into the pipe.

In some embodiments, an apparatus of the present invention comprises a flow diffuser located before the angular feed such that a fluid flowing through the flow diffuser into the angular feed is a fully developed flow. As used herein, a “flow diffuser” refers to a diaphragm, a membrane, a filter, an insert, a grating, and the like having holes, continuous pores, perforations, and the like there through. A flow diffuser can be prepared from any solid, porous, or flexible material, such as, but not limited to, metals (e.g., stainless steel, and the like), ceramics, plastics, wires (i.e., mesh), and the like, and composites thereof.

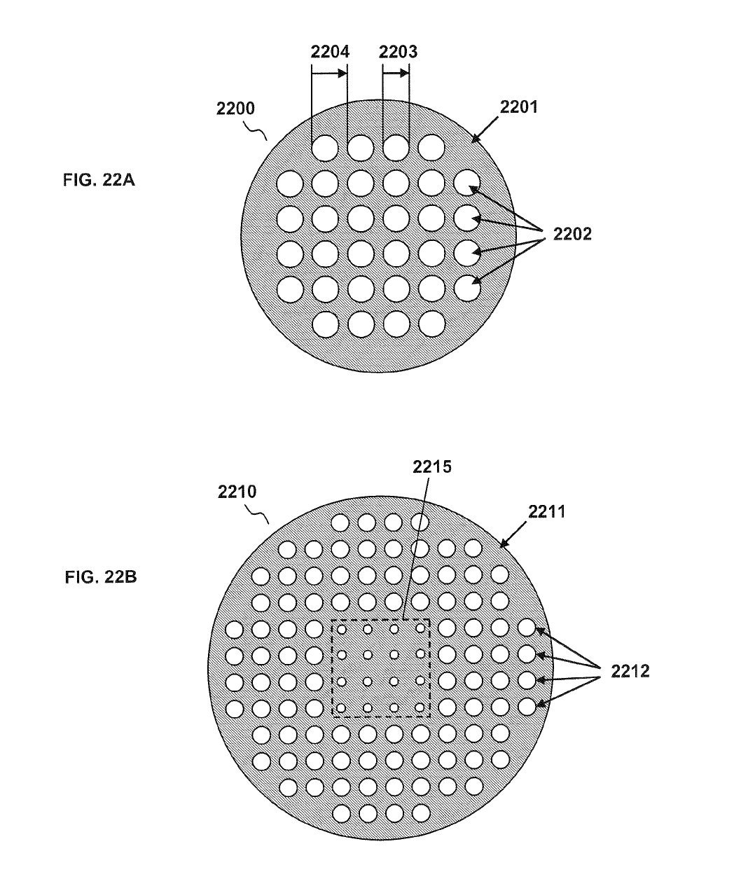

FIGS. 22A and 22B provides schematic representations of exemplary flow diffusers for use with the present invention. Referring to FIG. 22A, the flow diffuser, 2200, comprises a solid material, 2201, having a plurality of holes, 2202, there through. While the holes of diffuser 2200 are circular, other shapes and configurations can be utilized. For example, rectilinear (e.g., square, rectangular, and the like), ellipsoidal, triangular, pentagonal, hexagonal, and cross-shaped holes, and the like, can be utilized. The holes have a pitch, 2204, and a lateral dimension, 2203. The lateral dimension, 2203, can be about 10% to about 90% of the pitch.

In some embodiments, a flow diffuser has a plurality of holes with a diameter of about 5 mm and a pitch of about 7 mm. In some embodiments, a flow diffuser has a plurality of holes with a diameter of about 3 mm and a pitch of about 5 mm.

In some embodiments, a flow diffuser comprises two or more groups, or three or more groups of holes having different lateral dimensions. A schematic diagram of a flow diffuser having two groups of holes of different lateral dimensions is provided in FIG. 22B. Referring to FIG. 22B, the flow diffuser, 2210, comprises a solid body, 2211, having a first group of holes, 2212, having a first lateral dimension, and a second group of holes, 2215, having a second lateral dimension. The second group of holes, which is located near the center of the flow diffuser, has a lateral dimension less than the first groups of holes, which is around the periphery of the flow diffuser. A hole configuration such as that provided in the flow diffuser of FIG. 22B is particularly useful for inducing a fully developed flow in a conduit, pipe, tubing and the like, by placing the flow diffuser immediately after an increase in the diameter of the conduit, pipe, or tubing.

In some embodiments, a flow diffuser is located at a point immediately before an angular feed. In some embodiments, a flow diffuser is located at a point immediately after an expansion in the diameter of a tube or conduit.

In some embodiments, a flow diffuser induces a pressure drop in a flowing fluid of 10 kPa or less, 9 kPa or less, 8 kPa or less, 7 kPa or less, 6 kPa or less, 5 kPa or less, 4 kPa or less, 3 kPa or less, or 2 kPa or less. In some embodiments, a flow diffuser induces a pressure drop in a flowing fluid of 1 kPa to 10 kPa, 1 kPa to 7.5 kPa, 1 kPa to 5 kPa, 2 kPa to 10 kPa, 2 kPa to 7.5 kPa, 3 kPa to 9 kPa, 4 kPa to 8 kPa, or about 2 kPa, about 3 kPa, about 4 kPa, about 5 kPa, about 6 kPa, about 7 kPa, about 8 kPa, or about 10 kPa.

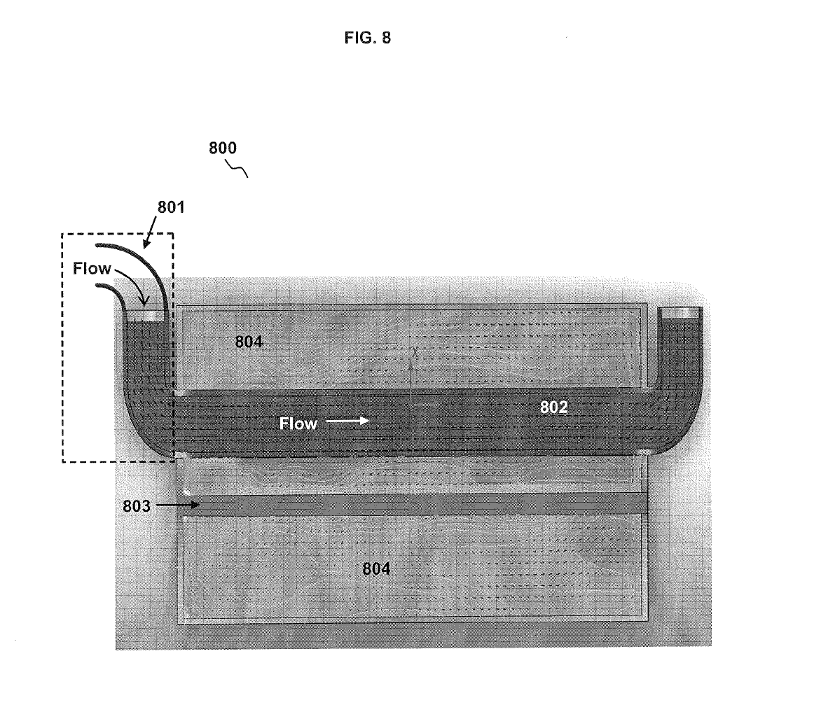

In reducing the distance between the light source and the ultraviolet-transmissive conduit by reducing the eccentricity of the elliptical cross-section, the temperature effect on fluid within conduit should also be considered. As noted above, increasing the temperature of a fluid, for example, water that is being treated, can increase the deposition of minerals, metals, and the like on an inner surface of the ultraviolet-transmissive conduit. FIG. 8 provides a schematic representation, 800, of thermal modeling results performed for an apparatus that include the low eccentricity ellipse of FIG. 5B (axial dimensions of 135 mm and 130 mm, with a focal length of 36.4 mm and an eccentricity of 0.27). Referring to FIG. 8, the thermal modeling included a fluid having the thermal conductivity of water flowing through an angular feed, 801, into an ultraviolet-transmissive conduit. The temperature profile, 804, surrounding the ultraviolet-transmissive conduit, generated by a UV light source, 803, positioned at a first focal point of the low eccentricity ellipse shows only a minor increase in temperature (suitably on the order of 1° C. to 2° C.). The simulation presented in FIG. 8 was conducted using a UV light source with a temperature of 383 K. In suitable embodiments, a listed operating temperature of a UV light source utilized in an apparatus of the present invention is about 250 Kelvin (“K”) to 350 K, more suitably 300 K to 320 K, 310 K to 315 K, about 300 K, about 310 K, about 320 K, or about 350 K.

The present invention also provides methods of treating a fluid, e.g., disinfecting water. As described herein, in exemplary embodiments, the fluid that is treated/disinfected by irradiation with ultraviolet light is water, including drinking water, municipal waste water, industrial waste water, sewer water, storm water, etc. In some embodiments, an apparatus and/or method of the present invention is suitable for inactivating a pathogen, a bacterium, a spore, an indicator, an organism, or a combination thereof. In some embodiments, the bacterium, spore, virus, protozoan, and the like is a bacterium, spore, virus, or protozoan found in human feces, sludge, and the like.

Non-limiting examples of pathogens, indicators, and organisms suitable for inactivation using an apparatus and/or method of the present invention include: spores such as, but not limited to, Bacillus subtilis ATCC6633, Bacillus subtilis WN626, and the like; bacterium such as, but not limited to, Aeromonas hydrophila ATCC7966, Aeromonas salmonicida, Campylobacter jejuni ATCC 43429, Citrobacter diversus, Citrobacter freundii, Escherichia coli ATCC 11229, Escherichia coli ATCC 11303, Escherichia coil ATCC 25922, Escherichia coli C, Escherichia coli O157:H7, Escherichia coli O157:H7CCUG 29193, Escherichia coli O157:H7CCUG 29197, Escherichia coli O157:H7CCUG 29199, Escherichia coli O157:H7 ATCC 43894, Escherichia coli O25:K98:NM, Escherichia coli 026, Escherichia coli O50:H7, Escherichia coli O78:H11, Escherichia coli K-12 IFO3301, Escherichia coli Wild type, Halohacterium elongata ATCC33173, Halobacterium salinarum ATCC43214, Klebsiella pneumoniae, Klebsiella terrigena ATCO33257, Legionella pneumophila ATCC 43660, Legionella pneumophila ATCC33152, Pseudomonas stutzeri, RB2256, Salmonella spp., Salmonella anatum, Salmonella derby, Salmonella enteritidis, Salmonella infantis (from human feces), Salmonella typhi ATCC 19430, Salmonella typhi ATCC 6539, Salmonella typhimurium, Shigella dysenteriae ATCC29027, Shigella sonnei ATCC9290, Staphylococcus aureus ATCC25923, Streptococcus faecalis ATCC29212, Streptococcus faecalis, Vibrio anguillarum, Vibrio cholerae ATCC25872, Vibrio natriegens, Yersinia enterocolitica ATCC27729, Yersinia ruckeri, and the like; protozoans such as, but not limited to, Cryptosporidium hominis, Coptosporidiwn parvum, Cryptosporidium canis, Cryptosporidium felis, Cryptosporidium meleagridis, Cryptosporidium muris, Encephalitozoon cuniculi (microsporidia), Encephalitozoon hellem (microsporidia), Encephalitozoon intestinalis (microsporidia), Giardia lamblia, Giardia marls, Giardia beckeri, Giardia heltrani, Giardia botauri, Giardia bovis, Giardia hradvpi, Giardia canis, Giardia caprae, Giardia cati, Giardia caviae, Giardia chinchillas, Giarclia dasi, Giardia equii, Giardia floridae, Giardia hegneri, Giardia herodiadis, Giardia hyderahadensis, Giardia irarae, Giardia marginalis, Giardia melospizae, Giardia nycticori, Giardia ondatrue, Giardia otomyis, Giardia pitymysi, Giardia pseudoardeae, Giardia recurvirostrae, Giardia sanguinis, Giardia serpentis, Giardia simoni, Giardia sturnellae, Giardia suricatae, Giardia tucani, Giardia varani, Giardia viscaciae, Giardia wenyoni, Plasmodium, Toxoplasma, and the like; viruses such as, but not limited to, PRD-1 (Phage), B40-8 (Phage), MS2 (Phage), MS2 DSM 5694 (Phage), MS2 ATCC 15977-B1 (Phage), MS2 NCIMB 10108 (Phage), MS2 (Phage), PHI X 174 (Phage), Staphylococcus aureus phage A 994 (Phage), Calicivirus canine, Adenovirus type 2, Adenovirus type 15, Adenovirus type 40, Adenovirus type 41, Poliovirus Type 1 ATCC Mahoney, Poliovirus Type 1 LSc2ab, Poliovirus 1, Coxsackievirus B5, Coxsackievirus B3, Reovirus-3, Reovirus Type 1 Lang Strain, Rotavirus, Rotavirus SA-11, Hepatitis A, Hepatitis A HM175, Echovirus I, Echovirus II, and the like, and combinations thereof.

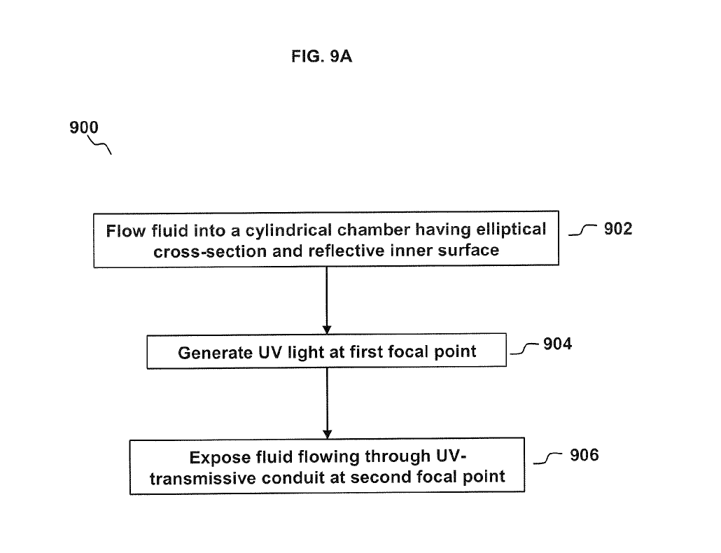

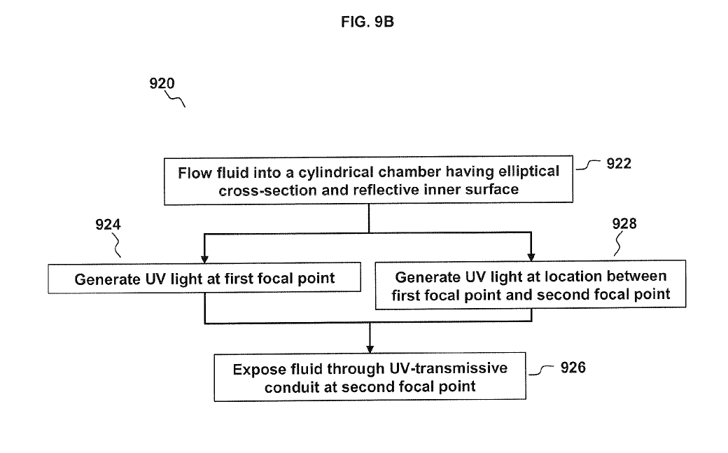

FIGS. 9A-9B provide flow charts for methods of treating a liquid in accordance with embodiments of the present invention. Referring to FIG. 9A, flowchart 900 comprises flowing a fluid into a cylindrical chamber having an elliptical cross-section and a reflective inner surface, 902, generating ultraviolet light at a first focal point within the cylindrical chamber, 904, and exposing a fluid that is flowing through an ultraviolet-transmissive conduit positioned at a second focal point within the cylindrical chamber, 906. Suitably, substantially all of the fluid flowing through the transmissive conduit is irradiated by the ultraviolet light.

Referring to FIG. 9B, flowchart 920 comprises flowing a fluid into a cylindrical chamber having an elliptical cross-section and a reflective inner surface, 902, generating ultraviolet light at a first focal point within the cylindrical chamber, 924, and/or generating ultraviolet light at a location between the first focal point and second focal point within the cylindrical chamber, 928, and using ultraviolet light generated in 924 and/or 928, exposing a fluid that is flowing through an ultraviolet-transmissive conduit positioned at a second focal point within the cylindrical chamber, 926. Suitably, substantially all of the fluid flowing through the transmissive conduit is irradiated by the ultraviolet light.

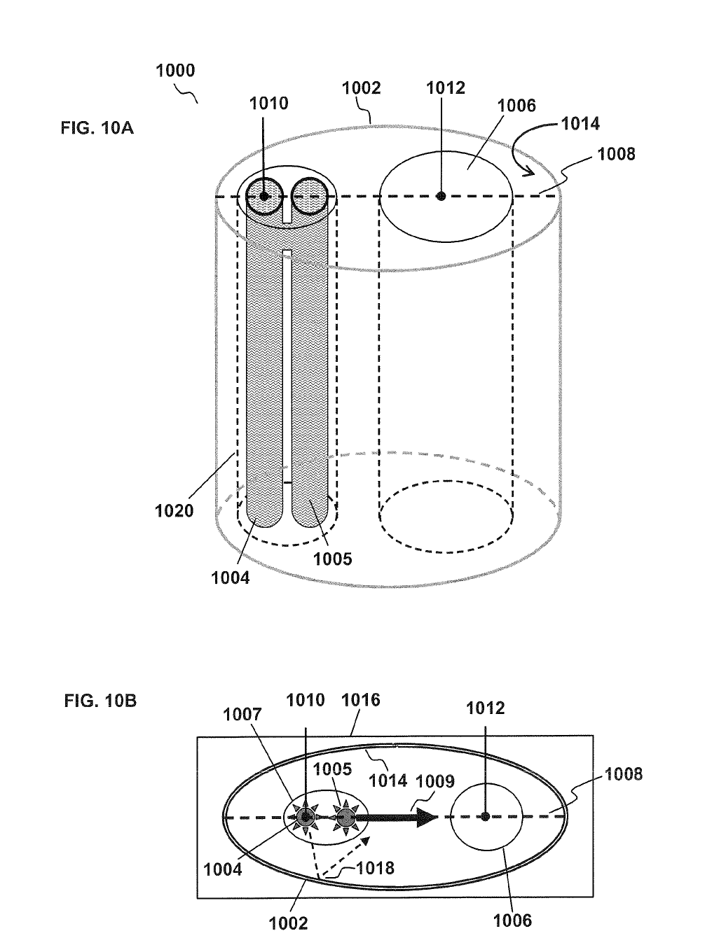

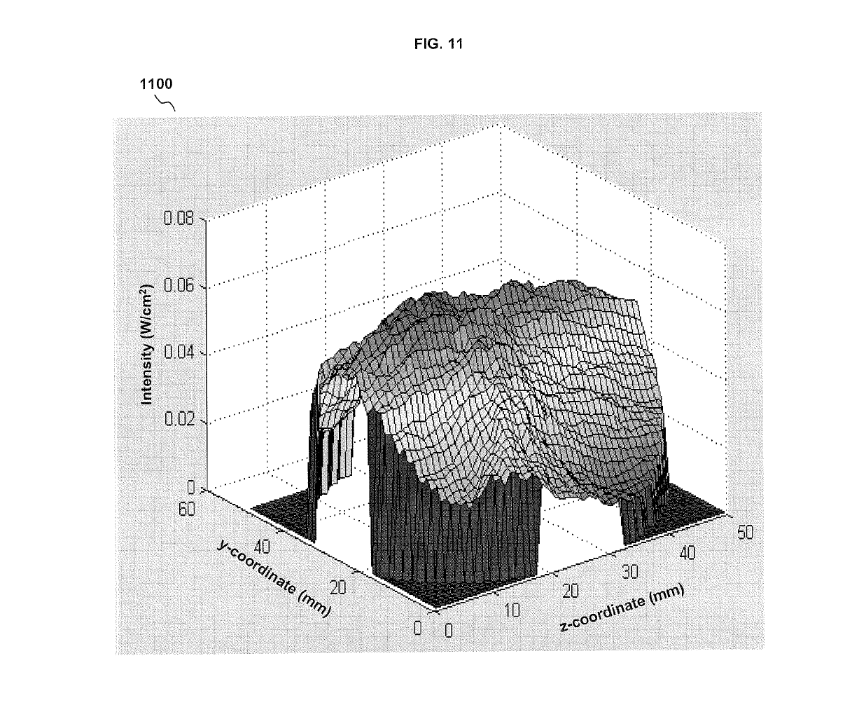

In a further embodiment, the present invention provides additional apparatuses for the treatment of a fluid, including water. As shown in FIGS. 10A-10B (FIG. 10B is a top-view cross-section of the apparatus shown in FIG. 10A), the apparatus 1000 suitably comprises a cylindrical chamber 1002 having an elliptical cross-section and a reflective inner surface 1014. As noted above, chamber 1002 can be placed in an enclosure having an arbitrary shape, 1016 in FIG. 10B, as a decorative element, to add to the structural integrity of the apparatus, and/or permit facile integration with other components and devices. A first ultraviolet light source 1004 is positioned at a first point on the major axis of the elliptical cross-section, 1008. In some embodiments, the first ultraviolet light source is located at a first focal point 1010 of the elliptical cross-section. An ultraviolet-transmissive conduit 1006, suitable for containing a fluid, and positioned at a second point on the major axis, 1008, and traverses a length of the cylindrical chamber 1002. In some embodiments, the ultraviolet-transmissive conduit 1006 is positioned at a second focal point 1012 of the elliptical cross-section. In some embodiments, the ultraviolet-transmissive conduit 1006 has a substantially circular cross-section with a diameter and length as described herein elsewhere. A second ultraviolet light source, 1005, is positioned on the major axis, 1008, between the first ultraviolet light source, 1004, and the ultraviolet-transmissive conduit 1006. As used herein “positioned between” refers to a physical location of second ultraviolet light source such that light can travel directly, 1009, from the second ultraviolet light source to the transmissive conduit.

Suitably, the first ultraviolet light source, 1004, and the second ultraviolet light source, 1005, are aligned along the major axis, 1008, of the elliptical cross-section of the cylindrical chamber 1002, as shown in FIGS. 10A and 10B. In some embodiments, the first 1004 and second 1005 ultraviolet light sources are aligned such that the centers of the ultraviolet light sources are directly posited along the major axis, 1008, with the first ultraviolet light source positioned at the first focal point 1010. In some embodiments, the center of the first ultraviolet light source is located at the focal point 1010 of the elliptical cross-section (or the center of the first UV light source is within 10-30% of the focal point), and the center of second ultraviolet light source is positioned at an angle relative to major axis 1008 (e.g., 0.1° to about 90°, suitably 0.1° to about 45°, or 0.1° to about 20°, relative to major axis 1008).

As shown in FIG. 10B, light emitted from the first UV light source 1004 is reflected, 1018, by the inner surface, 1014, of the cylindrical chamber, 1002. UV light emitted from second UV light source 1005 can directly irradiate the ultraviolet-transmissive conduit 1006, or irradiate the ultraviolet-transmissive conduit after reflecting from the inner surface of the chamber. The use of two UV light sources in an orientation as depicted in FIGS. 10A-10B results in substantially all of a fluid that is later flowed through the ultraviolet-transmissive conduit as it is irradiated by UV light.

As described herein, ultraviolet-transmissive conduit 1006 comprises an inlet and outlet that allow for introduction of a fluid into the ultraviolet-transmissive conduit, so as to pass fluid through chamber 1002. Suitable inlet and outlet connectors are known in the art, and include liquid-tight connectors that allow fluid flow without leakage. In some embodiments, an angular feed is attached to the ultraviolet-transmissive conduit to induce rotational mixing of a fluid that will be flowed into the ultraviolet-transmissive conduit. Thus, substantially all of a fluid flowed within the ultraviolet-transmissive conduit will be irradiated with UV light despite an optical configuration for the apparatus that provides non-uniform irradiance of the ultraviolet-transmissive conduit by the first and second UV light sources.

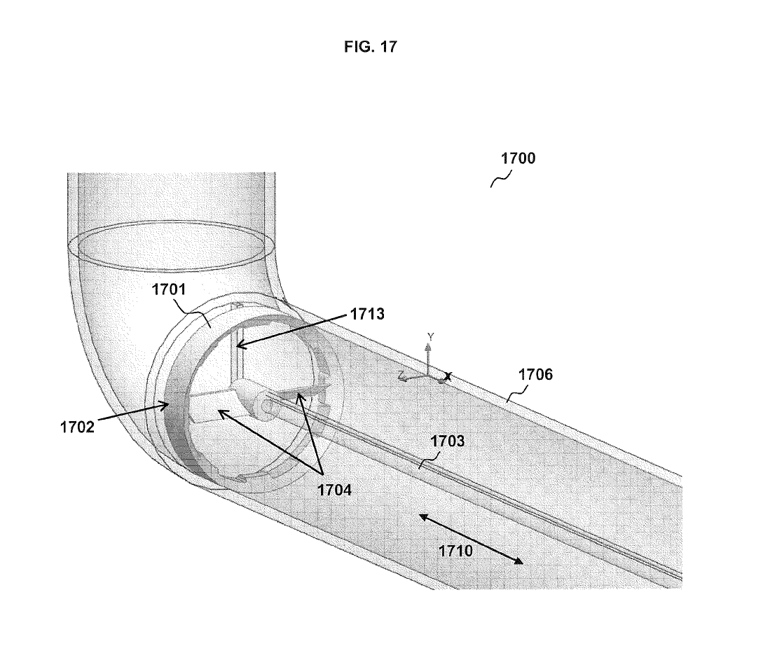

In some embodiments, an apparatus comprises a mixing device at a fixed position within the ultraviolet-transmissive conduit, wherein the mixing device comprises two or more fixed or rotating fins. For example, the mixing device can comprises two fixed fins similar in shape and position to the spokes, 1704, of a wiper, as shown in FIG. 17. In some embodiments, a plurality of spokes are located within the ultraviolet-transmissive conduit at fixed positions.

Not being bound by any particular theory, a mixing device located at a fixed point within the ultraviolet-transmissive conduit can facilitate uniform rotational mixing through the length of the ultraviolet-transmissive conduit, thereby enhancing dosage uniformity.

Referring to FIG. 10A, in suitable embodiments, first (1004) and second (1005) UV light sources are separate light sources, such as separate UV bulbs. In other embodiments, first and second UV light sources are a single, U-shaped UV bulb, as shown in FIG. 10A (i.e., a single UV bulb provides both the first and second UV light sources). The use of a U-shaped UV bulb can allow for a shorter chamber to be used, and as described herein, can also provide for a more uniform dose to the liquid in conduit 1006. Exemplary U-shaped UV bulbs that can be utilized in the apparatus of the present invention are known in the art, and include those described below in the following Table. In addition, specially produced UV bulbs can also be utilized in the practice of the present invention to meet the desired characteristics of the UV light source.

In some embodiments, multiple single-bulb or U-shaped bulbs are placed in series within the apparatus along the length of the ultraviolet-transmissive conduit (i.e., one after the other along the length of the chamber parallel to the ultraviolet-transmissive conduit). Thus, the orientation of elements depicted in cross-section of chamber 102 shown in FIG. 1B and chamber 1002 in FIG. 10B is maintained throughout the chamber length (except in spaces between bulbs).

TABLE
Exemplary U-shaped UV bulbs

| | Tube diam. | Tube diam. | | | Lamp | Lamp | Lamp | UV-C | | Depreciation | Useful |
|---|---|---|---|---|---|---|---|---|---|---|---|
| | (major axis, | (⊥ to major | Arc length | Bf-T2 | Wattage | Voltage | Current | 100 h | pW/cm² | at 9000 h | Lifetime |
| Bulb Type | mm) | axis, mm) | (mm) | (mm) | (W) | (V) | (A) | (W) | at 1 m | (%) | (h) |
| PHILLIPS ® TUV PL-S | 28 | 13 | 85 | 83 | 5 | 35 | 0.18 | 1 | 9 | 20 | 9000 |
| 5 W, 2-pin | | | | | | | | | | | |
| PHILLIPS ® TUV PL-S | 28 | 13 | 145 | 113 | 7 | 46 | 0.18 | 1.6 | 15 | 20 | 9000 |
| 7 W, 2-pin | | | | | | | | | | | |
| PHILLIPS ® TUV PL-S | 28 | 13 | 210 | 145 | 9 | 60 | 0.17 | 2.4 | 22 | 20 | 9000 |
| 9 W, 2-pin | | | | | | | | | | | |
| PHILLIPS ® TUV PL-S | 28 | 13 | 210 | 145 | 9 | 60 | 0.17 | 2.4 | 22 | 20 | 9000 |
| 9 W, 4-pin | | | | | | | | | | | |
| PHILLIPS ® TUV PL-S | 28 | 13 | 350 | 213 | 11 | 89 | 0.16 | 3.6 | 33 | 20 | 9000 |
| 11 W, 2-pin | | | | | | | | | | | |
| PHILLIPS ® TUV PL-S | 28 | 13 | 230 | 155 | 13 | 56 | 0.29 | 3.4 | 31 | 20 | 9000 |
| 13 W, 2-pin | | | | | | | | | | | |
| PHILLIPS ® TUV PL-L | 39 | 18 | 325 | 220 | 18 | 58 | 0.37 | 5.5 | 51 | 15 | 9000 |
| 18 W, 4-pin | | | | | | | | | | | |
| PHILLIPS ® TUV PL-L | 39 | 18 | 515 | 315 | 24 | 87 | 0.35 | 7 | 65 | 15 | 9000 |
| 24 W, 4-pin | | | | | | | | | | | |
| PHILLIPS ® TUV PL-L | 39 | 18 | 325 | 220 | 38 | 55 | 0.85 | 11 | 105 | 15 | 9000 |
| 35 W, HO 4-pin | | | | | | | | | | | |
| PHILLIPS ® TUV PL-L | 39 | 18 | 705 | 410 | 36 | 106 | 0.44 | 12 | 110 | 15 | 9000 |
| 36 W, 4-pin | | | | | | | | | | | |
| PHILLIPS ® TUV PL-L | 39 | 18 | 955 | 535 | 55 | 105 | 0.53 | 17 | 156 | 15 | 9000 |
| 55 W, HF 4-pin | | | | | | | | | | | |
| PHILLIPS ® TUV PL-L | 39 | 18 | 705 | 410 | 65 | 82 | 0.80 | 19 | 235 | 15 | 9000 |
| 60 W, HO 4-pin | | | | | | | | | | | |
| PHILLIPS ® TUV PL-L | 39 | 18 | 955 | 535 | 90 | 115 | 0.80 | 27 | 250 | 15 | 9000 |
| 95 W, HO 4-pin | | | | | | | | | | | |

Referring to FIGS. 1A and 10A, as described herein, in exemplary embodiments, the elliptical cross-section of chamber 102 and 1002, respectively, has an eccentricity of 0 to 0.5, suitably 0 to 0.4, 0 to 0.3, 0 to 0.2, 0 to 0.1, and more suitably, about 0.20, about 0.21, about 0.22, about 0.23, about 0.24, about 0.25 about 0.26, about 0.27, about 0.28, about 0.29 or about 0.30.

In suitable embodiments, elliptical cross-section of cylindrical chamber 102 and 1002, respectively, for use in the apparatus shown in FIGS. 1A and 10A, respectively, has a focal length of 10 mm to 50 mm, suitably, 20 mm to 50 mm, 20 mm to 40 mm, 30 mm to 40 mm, 35 mm to 40 mm, about 30 mm, about 31 mm, about 32 mm, about 33 mm, about 34 mm, about 35 mm, about 36 mm, about 36.1 mm, about 36.2 mm, about 36.3 mm, about 36.4 mm, about 36.5 mm, about 36.6 mm, about 36.7 mm, about 36.8 mm, about 36.9 mm, about 37 mm, about 38 mm, about 39 mm or about 40 mm.

Referring to FIGS. 10A-10B, suitably, an elliptical cross-section has the shape of a low eccentricity ellipse with a major axis, 1008, having a length (from end to end of the ellipse along the major axis) of 50 mm to 300 mm, 60 mm to 200 mm, 75 mm to 100 mm, e.g., about 75 mm, about 80 mm, about 85 mm, about 90 mm, about 85 mm or about 100 mm. In exemplary embodiments, the dimension of a low eccentricity ellipse for use in the embodiment shown in FIGS. 10A and 10B along the minor axis 204 is 60 mm to 300 mm, 60 mm to 200 mm, suitably 70 mm to 100 mm, or 70 mm to 80 mm, for example 70 mm to 75 mm, about 72 mm, about 73 mm, or about 72.2 mm. It should be noted that larger or smaller focal lengths can also be used. In addition, the size of chamber 102 can be readily scaled, while still maintaining the ratio of dimensions of the major and minor axes of 1.036 to 1.042 (major: minor), suitably 1.038 to 1.039.

The positioning of light sources 1004 and 1005, and conduit 1006, within chamber 1002, and selection of appropriate characteristics of the light sources, as well as eccentricity of the ellipse, and an angular feed, provide that substantially all the fluid within ultraviolet-transmissive conduit 1006 is irradiated by the ultraviolet light source(s), despite a non-uniform irradiance of the ultraviolet-transmissive conduit, 1006, by the UV light source(s).

FIG. 11 provides a three-dimensional plot of light intensity versus y- and z-coordinates within the apparatus of FIGS. 10A and 10B determined using a modeling simulation. The modeling simulation utilized two 36 watt U-bulb lamps positioned end-to-end along the length of the cylindrical chamber, each bulb having a length of about 41 cm. The chamber in the simulation had a length of 90 cm and an ellipsoidal cross-section with a major axis length of 15 cm and a minor axis length of 14.5 cm. As shown in FIG. 11, results of modeling the UV intensity within the ultraviolet-transmissive conduit shows that a section of highest intensity is present in the center of the ultraviolet-transmissive conduit, aligned with the major axis of the ellipse. This high-intensity volume results from the irradiation provided by the second UV light source that is positioned between the first UV light source and the ultraviolet-transmissive conduit, which provides direct UV light, while the parabolic shape of the intensity profile results from the UV light source located at the focal point of the ellipse.

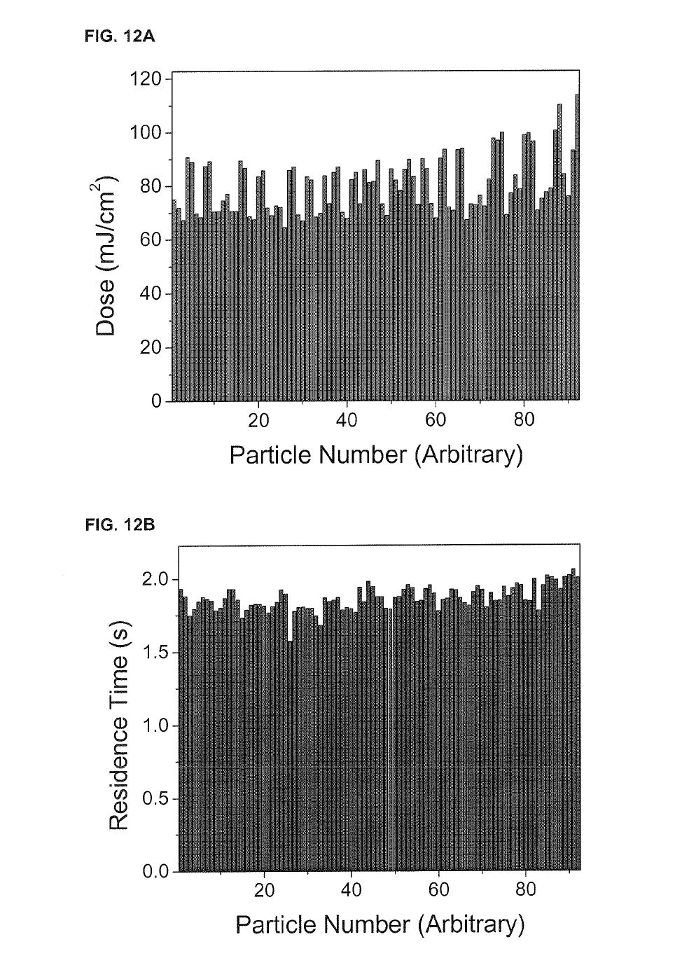

FIGS. 12A and 12B provide graphic representations of the results of dosage and residence time modeling applied to “particles” within a fluid that will be flowed through the ultraviolet-transmissive conduit of the apparatus of FIGS. 10A and 10B. “Particles” are simulated by the model to mimic bacteria or viruses flowing through the ultraviolet-transmissive conduit. In the model, a 72 W U-bulb lamp was utilized, having a length of 90 cm. The results in FIG. 12A indicate a minimum dosage of about 65 mJ/cm² is obtained for all “particles” that pass through the ultraviolet-transmissive conduit. FIG. 12B shows that the particles in the model flow through the ultraviolet-transmissive conduit with a uniform residence time.

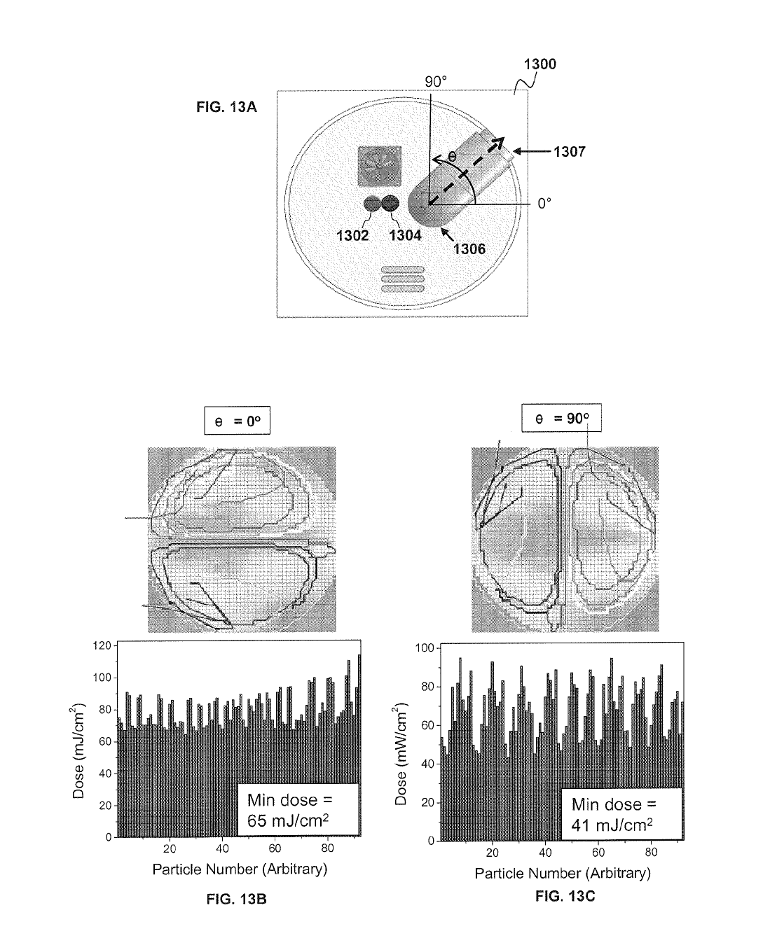

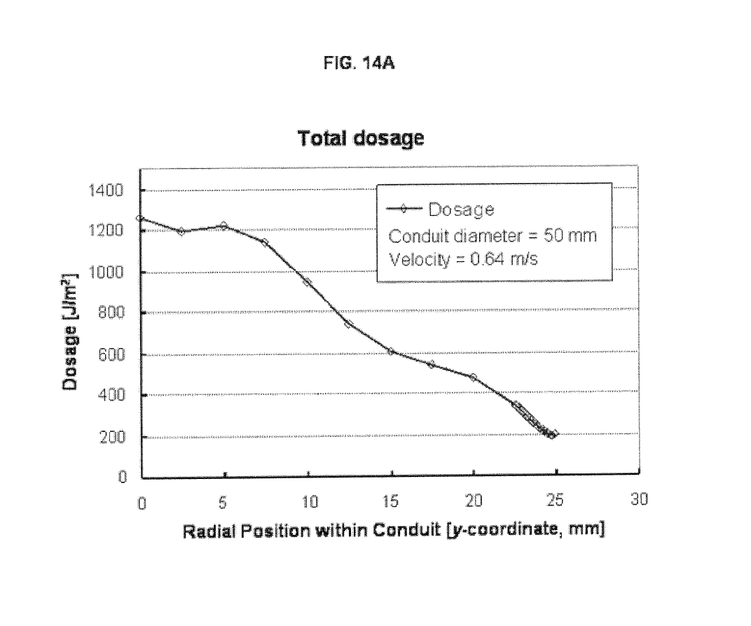

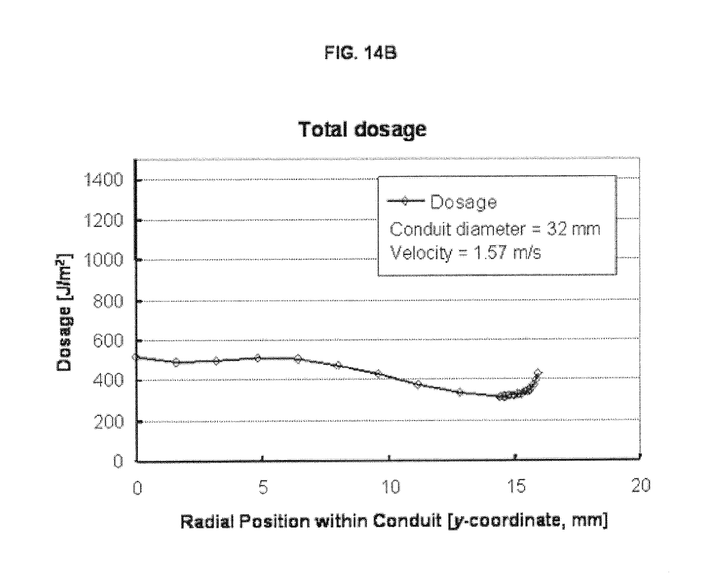

FIG. 13A provides a top-view schematic of an apparatus of the present invention indicating the angle of entry as an adjustable variable. Referring to FIG. 13A, the schematic, 1300, depicts the variability in the angle (θ) of an angular feed, 1307, supplying a fluid to ultraviolet-transmissive conduit 1306. By varying the angle θ of the angular feed relative to the conduit the irradiance of the flowing fluid can be varied. This is because the angular feed induces rotational mixing of a fluid that will be flowed within the ultraviolet-transmissive conduit.

FIGS. 13B-13C provide graphic representations of the effects of variations in the angle of entry on the irradiation dose of a fluid flowing in an apparatus of the present invention as determined by modeling simulations. Referring to the top pane of FIG. 13B, at θ=0°, the modeled particles had the longest residence time within the volume of high-intensity UV light within the ultraviolet-transmissive conduit. Examining the dose transferred to modeled particles within the fluid results in a minimum dose of about 65 mJ/cm², as demonstrated in the model results shown at the bottom pane of FIG. 13B.

In contrast, utilizing an inlet angle θ=90° produces a flow profile with the orientation shown in FIG. 13C. In this orientation, particles within the fluid spend less time within the high intensity section within conduit produced by the first and second UV light sources. Therefore, the overall dose of UV light delivered to the particles is reduced. As shown in FIG. 13C, a minimum dose of only 41 mJ/cm² is achieved, and the overall uniformity of the dose is also reduced when modeled.

First and second UV light sources suitably generate light at a wavelength of 10 nm to 400 nm. Suitably, UV light generated by UV light source is UV-C, or short wave UV light, with a wavelength (λ) of 100-280 nm, suitably about 254 nm. UV-A, or long wave UV light (λ=320-400 nm), as well as UV-B, or medium wave UV light (λ=280 nm to 320 nm), can also be utilized. Suitably, first and second UV light sources can generate UV light that serves to reduce the activity of bacteria, or kill bacteria, in a fluid (e.g., water), for example, light at about 254 nm, and can also generate UV light which generates oxygen radicals, for example, light at about 185 nm. The shorter-wavelength UV light at about 185 nm generates oxygen radicals (e.g., ozone) upon irradiation of an aqueous fluid that is flowed into the apparatus, which in turn oxidizes organic molecules present in the aqueous fluid.

Referring to FIG. 10B, in some embodiments, a diffuser, lens, or other optical element can be placed between ultraviolet light sources 1004 and 1005, and conduit 1006 to control the intensity or amount of irradiation. In exemplary embodiments, an ultraviolet-transmissive sheath 1007 surrounds ultraviolet light sources 1004 and 1005. Ultraviolet-transmissive sheath refers to a cover, tube, encapsulant or other casing which surrounds, or at least partially surrounds, UV light sources, and suitably surrounds the entire length of the UV light sources. Suitably, ultraviolet-transmissive sheath comprises a glass, a polymer, or other material. Suitably the sheath is quartz and is on the order of 10's of microns, to a few millimeters, to 10's of millimeters, in thickness. The shape of ultraviolet-transmissive sheath 120 can take any form that encloses the first and second UV light sources, including cylindrical shapes with circular, elliptical, rectangular, square, or other cross-sections. Ultraviolet-transmissive sheath can directly contact the outer surface of the UV light sources, or can be spaced a few millimeters, to 10's of millimeters (e.g., 5 mm to 50 mm) from the surface of the UV light sources.

FIG. 6 provides a three-dimensional cross-sectional representation of an apparatus of the present invention. Referring to FIG. 6, apparatus 600 comprises chamber 602 having an elliptical cross-section, an ultraviolet-transmissive conduit 606 and ultraviolet light source 604. Suitably, as shown, the ends of ultraviolet-transmissive conduit comprises angular feeds 607 that will induce rotational mixing in a fluid that will be flowed through the ultraviolet-transmissive conduit. Angular feeds 607 can be positioned at various angles relative to the axis of the chamber, and suitably are at an angle of 70° to 120° relative to the chamber axis, and more suitably, are right angles (i.e., about 90°) to the chamber axis. The angle and orientation of the angular feeds can be optimized so as to increase the mixing of a fluid flowing through the ultraviolet-transmissive conduit. Parameters that can be optimized include the orientation of the angular feeds (both the inlet and outlet) relative to the chamber as well as to each other (e.g., inlet comes from above the chamber, outlet empties below the chamber), and also includes the number, orientation and complexity of the angle feeds that are used to introduce the fluid into the chamber.

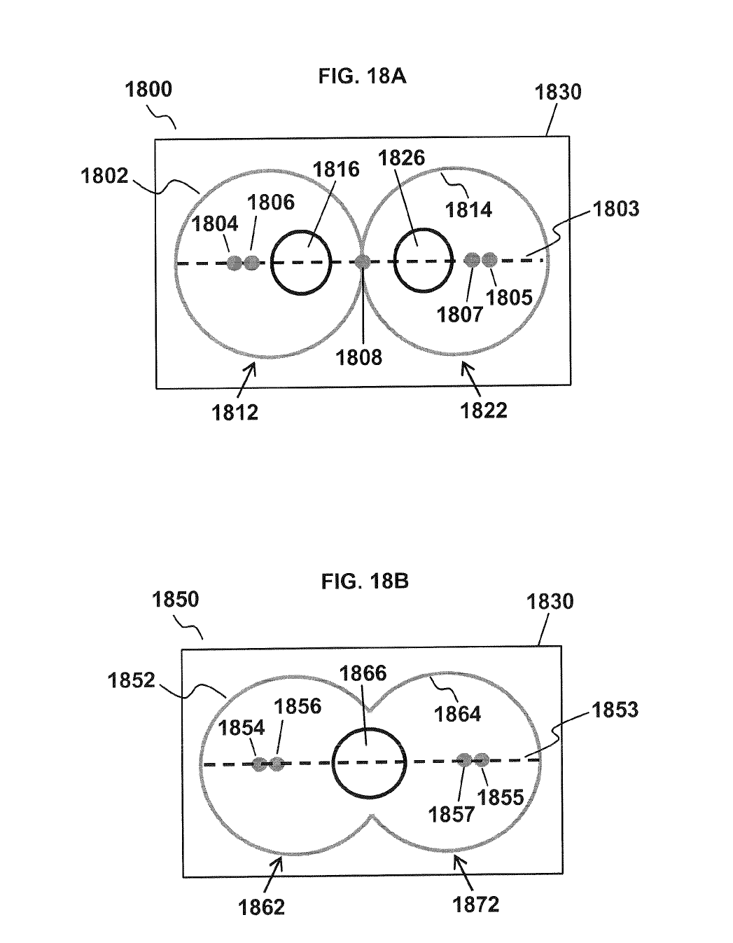

FIG. 18A provides a schematic cross-sectional diagram of an apparatus of the present invention. Referring to FIG. 18A, apparatus 1800 comprises a cylindrical chamber, 1802, having a double-elliptical cross-section provided by partially overlapping first, 1812, and second, 1822, ellipses, wherein the ellipses have co-linear major axes, 1803, and wherein the cylindrical chamber includes a reflective inner surface 1814. A first ultraviolet light source, 1804, is positioned at a first point on the major axis of the first ellipse, 1812, of the double-elliptical cross-section, 1802. A second ultraviolet light source, 1805, is positioned at a first point on the major axis of the second ellipse, 1822, of the double-elliptical cross-section. The apparatus also comprises an ultraviolet-transmissive conduit suitable for containing a fluid, wherein a first portion of the ultraviolet-transmissive conduit, 1816, traverses a length of the cylindrical chamber and is positioned at a second point on the major axis of the first ellipse, and a second portion of the ultraviolet-transmissive conduit, 1826, traverses a length of the cylindrical chamber and is positioned at a second point on the major axis of the second ellipse. A third ultraviolet light source, 1806, is positioned within the cylindrical chamber on the major axis of the first ellipse between the first ultraviolet light source, 1804, and the first portion of the ultraviolet-transmissive conduit, 1816. A fourth ultraviolet light source, 1807, is positioned within the cylindrical chamber on the major axis of the second ellipse between the second ultraviolet light source, 1805, and the second portion of the ultraviolet-transmissive conduit, 1826. A fifth ultraviolet light source, 1808, is positioned within the cylindrical chamber between the first, 1816, and second, 1826, portions of the ultraviolet-transmissive conduit and on the overlapping major axes of the first and second ellipses, 1803. The first 1804, second 1805, third 1806, fourth 1807, and fifth 1808 ultraviolet light sources provide a non-uniform irradiance of the first 1816, and second 1826, portions of the ultraviolet-transmissive conduit, and substantially all of a fluid flowed through the ultraviolet-transmissive conduit, 1816 and 1826, is irradiated by ultraviolet light.

Referring to FIG. 18A, in some embodiments, the first portion of the ultraviolet-transmissive conduit, 1816, is positioned at the second focus of the first ellipse, 1812, and the second portion of the ultraviolet-transmissive conduit, 1826, is positioned at the second focus of the second ellipse, 1822. In some embodiments, the first ultraviolet light source, 1804, is positioned at the first focus of the first ellipse, 1812, and the second ultraviolet light source, 1805, is positioned at the first focus of the second ellipse, 1822. In some embodiments, the ultraviolet light sources are U-shaped ultraviolet bulbs, or another suitable UV-bulb as described herein elsewhere.

FIG. 18B provides a schematic cross-sectional diagram of an apparatus of the present invention. Referring to FIG. 18B, apparatus 1850 comprises a cylindrical chamber, 1852, having a double-elliptical cross-section provided by partially overlapping first, 1862, and second, 1872, ellipses, wherein the ellipses have co-linear major axes, 1853, and overlapping second focal points, and wherein the cylindrical chamber includes a reflective inner surface, 1864. A first ultraviolet light source, 1854, is positioned at a first point on the major axis of the first ellipse, 1862, of the double-elliptical cross-section, 1852. A second ultraviolet light source, 1855, is positioned at a first point on the major axis of the second ellipse, 1872, of the double-elliptical cross-section, 1852. An ultraviolet-transmissive conduit, 1866, suitable for containing a fluid is positioned at the overlapping second focal points of the first, 1862, and second, 1872, ellipses, and traverses a length of the cylindrical chamber. A third ultraviolet light source, 1856, is positioned within the cylindrical chamber on the major axis of the first ellipse, 1862, between the first ultraviolet light source, 1854, and the ultraviolet-transmissive conduit, 1866. A fourth ultraviolet light source, 1857, is positioned within the cylindrical chamber, 1852, on the major axis of the second ellipse, 1872, between the second ultraviolet light source, 1855, and the ultraviolet-transmissive conduit, 1866. The first 1854, second 1855, third 1856, and fourth 1857, ultraviolet light sources provide a non-uniform irradiance of the ultraviolet-transmissive conduit 1866, and substantially all of a fluid flowed through the ultraviolet-transmissive conduit is irradiated by ultraviolet light.

In some embodiments, the apparatus depicted in FIGS. 18A-18B comprise an angular feed (not shown, but described herein elsewhere) is attached to the ultraviolet-transmissive conduit such that a fluid flowed into the ultraviolet-transmissive conduit undergoes rotational mixing. In some embodiments, the apparatus depicted in FIGS. 18A-18B comprise an enclosure, 1830, which is described herein elsewhere.

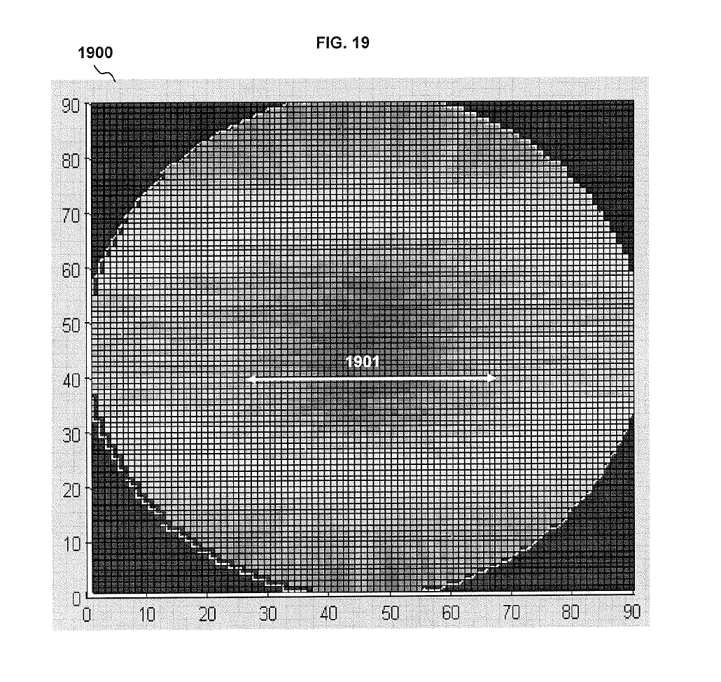

FIG. 19 provides a graphic representation, 1900, of the distribution of light irradiation across an ultraviolet-transmissive conduit of the apparatus of FIG. 18B, as determined using a modeling simulation. Referring to FIG. 19, the first, second, third, and fourth UV light sources provide an intense horizontal band, 1901, of UV-light across the ultraviolet-transmissive conduit. Alignment of the light intensity with the rotational mixing of a fluid to maximize the residence of time of the fluid within the intense light band (as described in FIGS. 13A-13B) provides uniform irradiance of a fluid flowed within the ultraviolet-transmissive conduit, despite the non-uniform irradiation of the ultraviolet-transmissive conduit by the UV light sources.

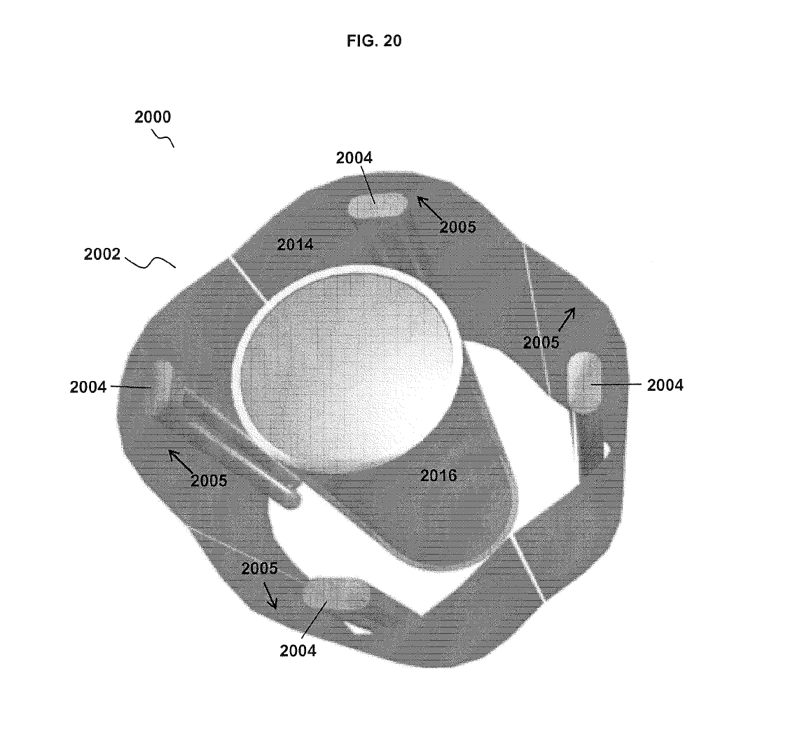

FIG. 20 provides a three-dimensional cross-sectional representation of an apparatus of the present invention. Referring to FIG. 20, apparatus 2000 comprises an ultraviolet-transmissive conduit, 2016, suitable for containing a fluid, wherein the ultraviolet-transmissive conduit positioned within and traversing a length of a cylindrical chamber, 2002, that includes a reflective inner surface, 2014. An angular feed is attached to the ultraviolet-transmissive conduit such that a fluid flowed into the ultraviolet-transmissive conduit undergoes rotational mixing (not shown). A plurality of ultraviolet light sources, 2004, are positioned in an even distribution around the ultraviolet-transmissive conduit, 2016, and each ultraviolet light source including a parabolic reflector, 2005. The ultraviolet light sources, 2004, provide a non-uniform irradiance of the ultraviolet-transmissive conduit, 2016, and substantially all of a fluid that will be flowed through the ultraviolet-transmissive conduit will be irradiated by ultraviolet light.

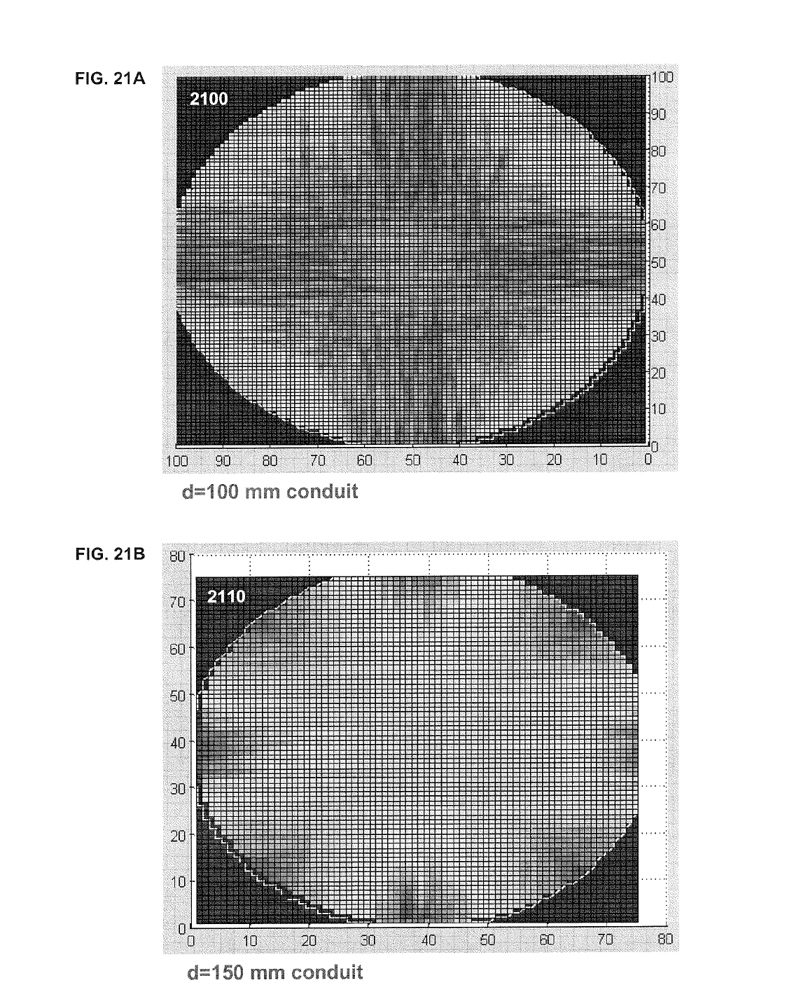

FIGS. 21A-21B provide graphic representations, 2100 and 2110, respectively, of the distribution of light irradiation within apparatus of FIG. 20 determined using modeling simulations. The modeling simulations for FIGS. 21A and 21B used the following parameters: lamp intensity 85 W, a lamp-to-conduit distance of 45 mm, parabolic reflector having a focal length of 21 mm, and the diameter of the conduit was 100 mm and 150 mm, respectively. Referring to FIG. 21A, for a conduit diameter of 100 mm, intense bands of UV light penetrated the full volume of the conduit. Conversely, referring to FIG. 21B, a conduit diameter of 150 mm resulted in a failure to irradiate the inner volume of the conduit with UV light. Thus, a balance between lamp intensity and conduit diameter is necessary in order to irradiate substantially all of a fluid flowed within the conduit using an apparatus of FIG. 20.

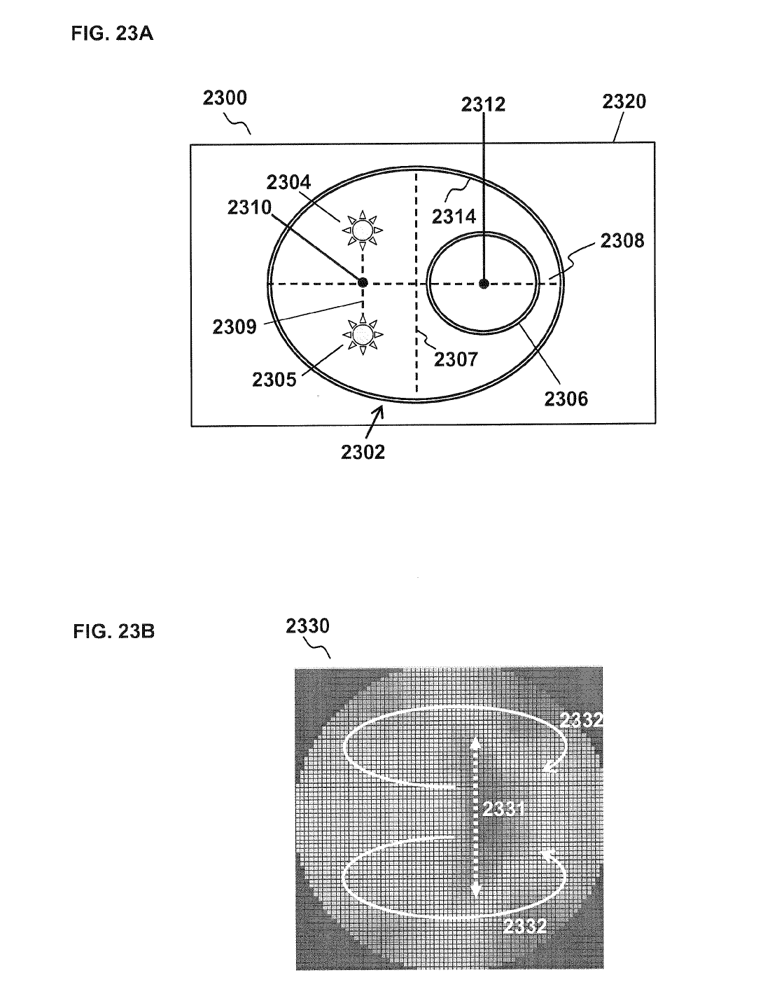

FIG. 23A provides a schematic cross-sectional diagram of an apparatus of the present invention. Referring to FIG. 23A, apparatus 2300 comprises a cylindrical chamber, 2302, having an elliptical cross-section that includes a major axis, 2308, a minor axis, 2307, and a reflective inner surface, 2314. The apparatus comprises an ultraviolet-transmissive conduit, 2306, suitable for transmitting a fluid and positioned at a first point on the major axis, 2312. A first ultraviolet light source, 2304, and a second ultraviolet light source, 2305, are positioned within the cylindrical chamber substantially equidistant from the ultraviolet-transmissive conduit, 2306, and on opposite sides of the major axis, 2308, of the elliptical cross-section. In some embodiments, the ultraviolet light sources, 2304 and 2305, are on an opposite side of the minor axis, 2307, from the ultraviolet-transmissive conduit, 2306. The first 2304 and second 2305 ultraviolet light sources provide a non-uniform irradiance of the ultraviolet-transmissive conduit, 2306, and when a fluid is flowed into the ultraviolet-transmissive conduit substantially of the flowed fluid will be irradiated by ultraviolet light.

Referring to FIG. 23A, first 2304 and second 2305 ultraviolet light sources are positioned equidistant from a major axis, 2308, of the elliptical cross-section. In some embodiments, a central point of an axis, 2309, passing through the centers of the first 2304 and second 2305 ultraviolet light sources is positioned at a first focus, 2310, of the elliptical cross-section. In some embodiments, the ultraviolet-transmissive conduit, 2306, is positioned at a second focus, 2312, of the elliptical cross-section. In some embodiments, the apparatus depicted in FIG. 23A comprises a mixing system configured to induce mixing of a fluid that is flowed into the ultraviolet-transmissive conduit. In some embodiments, the apparatus depicted in FIG. 23A comprises an enclosure, 2320, which is described herein elsewhere.

FIG. 23B provides a graphic representation, 2330, of the light intensity distribution within a cross-section of the ultraviolet-transmissive conduit of the apparatus of FIG. 23A, as determined using a modeling simulation. Referring to FIG. 23B, the first and second ultraviolet light sources provide for non-uniform irradiation of the ultraviolet-transmissive conduit. The non-uniform irradiation is characterized by an intense band, 2331, of ultraviolet light across the ultraviolet-transmissive conduit. However, of the non-uniform irradiation with rotational mixing, 2332, of a fluid that will be flowed into the apparatus results in uniform irradiation of the fluid. Furthermore, the residence time of a fluid within the intense region of ultraviolet light is optimized, resulting in substantially all of the fluid being irradiated, despite the non-uniform irradiation of the ultraviolet-transmissive conduit by the UV light sources.

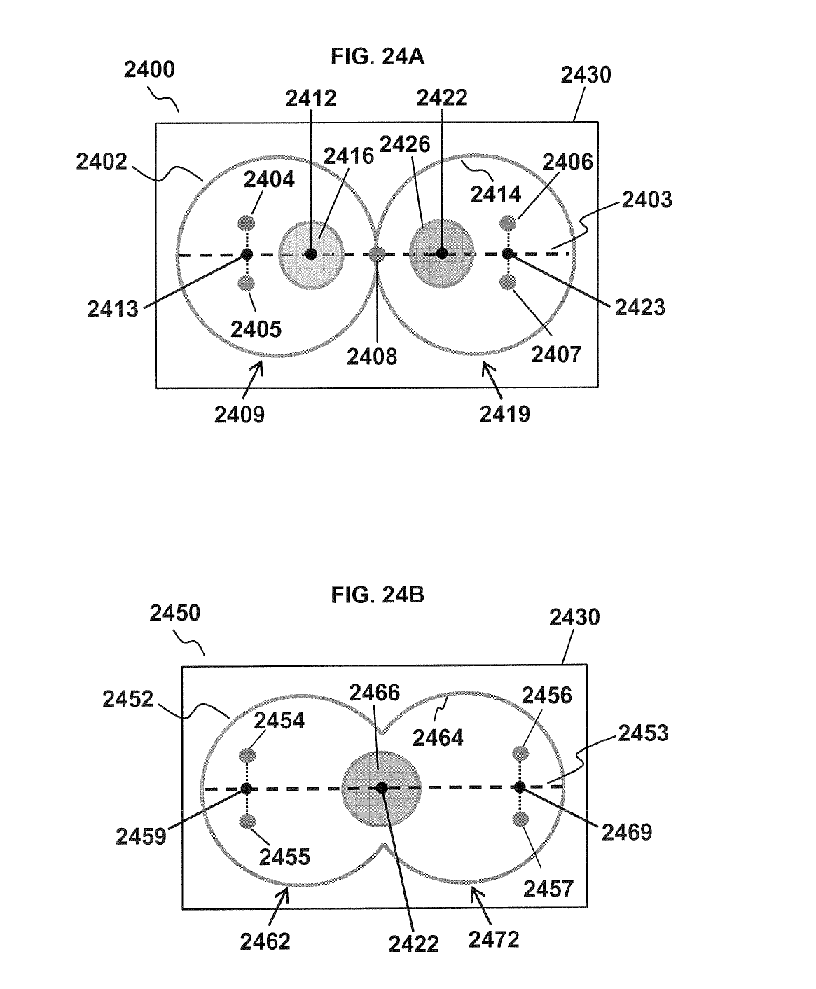

FIG. 24A provides a schematic cross-sectional diagram of an apparatus of the present invention. Referring to FIG. 24A, apparatus 2400 comprises a cylindrical chamber, 2402, having a double-elliptical cross-section provided by partially overlapping first, 2409, and second, 2419, ellipses, wherein the ellipses have co-linear major axes, 2403, and wherein the cylindrical chamber includes a reflective inner surface 2414. The apparatus also comprises an ultraviolet-transmissive conduit suitable for transmitting a fluid, wherein a first portion of the ultraviolet-transmissive conduit, 2416, traverses a length of the cylindrical chamber and is positioned at a first point on the major axis of the first ellipse, and a second portion of the ultraviolet-transmissive conduit, 2426, traverses a length of the cylindrical chamber and is positioned at a first point on the major axis of the second ellipse. A first ultraviolet light source, 2404, and a second ultraviolet light source, 2405, are positioned within the cylindrical chamber, 2402, wherein the first 2404 and second 2405 ultraviolet light sources are substantially equidistant from the first portion of the ultraviolet-transmissive conduit, 2416, and on opposite sides of the major axis of the first ellipse. Third, 2406, and fourth, 2407, ultraviolet light sources are positioned within the cylindrical chamber, 2402, wherein the third, 2406, and fourth, 2407, ultraviolet light sources are substantially equidistant from the second portion of the ultraviolet-transmissive conduit, 2426, and on opposite sides of the major axis of the second ellipse. A fifth ultraviolet light source, 2408, is positioned within the cylindrical chamber between the first, 2416, and second, 2426, portions of the ultraviolet-transmissive conduit and on the overlapping major axes, 2403. The first through fifth ultraviolet light sources, 2404-2408, provide non-uniform irradiance of the first, 2416, and second, 2426, portions of the ultraviolet-transmissive conduit, and substantially all of a fluid flowing through the ultraviolet-transmissive conduit, 2416 and 2426, is irradiated by ultraviolet light.

Referring to FIG. 24A, in some embodiments, the first portion of the ultraviolet-transmissive conduit, 2416, is positioned at a second focus of the first ellipse, 2412, and the second portion of the ultraviolet-transmissive conduit, 2426, is positioned at a second focus of the second ellipse, 2422. In some embodiments, the first, 2404, and second, 2405, ultraviolet light sources are equidistant from the major axis of the first ellipse. In some embodiments, the third, 2406, and fourth, 2407, ultraviolet light sources are equidistant from the major axis of the second ellipse. In some embodiments, a central point of an axis passing through the centers of the first 2404 and second 2405 ultraviolet light sources is positioned at a first focus of the first ellipse, 2413. In some embodiments, a central point of an axis passing through the centers of the third 2406 and fourth 2407 ultraviolet light sources is positioned at a first focus of the second ellipse, 2423. In some embodiments, the ultraviolet light sources are U-shaped ultraviolet bulbs, H-shaped ultraviolet bulbs, or a combination thereof, or another suitable UV-bulb as described herein elsewhere.

FIG. 24B provides a schematic cross-sectional diagram of an apparatus of the present invention. Referring to FIG. 24B, apparatus 2450 comprises a cylindrical chamber, 2452, having a double-elliptical cross-section provided by partially overlapping first, 2462, and second, 2472, ellipses, wherein the ellipses have co-linear major axes, 2453, and overlapping second focal points, and wherein the cylindrical chamber includes a reflective inner surface, 2464. An ultraviolet-transmissive conduit, 2466, suitable for transmitting a flowing fluid is positioned at the overlapping second focal points of the first, 2462, and second, 2472, ellipses, and traverses a length of the cylindrical chamber. A first ultraviolet light source, 2454, and a second ultraviolet light source, 2455, are positioned within the first ellipse of the cylindrical chamber, 2452, wherein the first, 2454, and second, 2455, ultraviolet light sources are substantially equidistant from the ultraviolet-transmissive conduit, 2466, and on opposite sides of the major axis of the first ellipse. A third ultraviolet light source, 2456, and a fourth ultraviolet light source, 2457, are positioned within a second ellipse of the cylindrical chamber, 2452, wherein the third, 2456, and fourth, 2457, ultraviolet light sources are substantially equidistant from the ultraviolet-transmissive conduit, 2466. The first through fourth ultraviolet light sources, 2454-2457, provide a non-uniform irradiance of the ultraviolet-transmissive conduit 2466, such that substantially all of a fluid flowed through the ultraviolet-transmissive conduit is irradiated by ultraviolet light.

Referring to FIG. 24B, in some embodiments, the first through fourth ultraviolet light sources, 2454-2457, respectively, are equidistant from the major axis, 2453, of the double-elliptical cross-section. In some embodiments, a central point of an axis passing through the centers of the first, 2454, and second, 2455, ultraviolet light sources is positioned at a first focus of the first ellipse, 2459, and a central point of an axis passing through the centers of the third, 2456, and fourth, 2457, ultraviolet light sources is positioned at a first focus of the second ellipse, 2469. In some embodiments, the ultraviolet light sources are U-shaped ultraviolet bulbs, H-shaped ultraviolet bulbs, or a combination thereof, or another suitable UV-bulb as described herein elsewhere.

In some embodiments, the apparatus depicted in FIGS. 24A-24B comprise a mixing system configured to induce mixing of a fluid. In some embodiments, the apparatus depicted in FIGS. 24A-24B comprise an enclosure, 2430, which is described herein elsewhere.

In some embodiments, an apparatus of the present invention comprises a mixing system configured to induce mixing of the fluid, wherein the mixing system is located at least partially in the ultraviolet-transmissive conduct. For example, the mixing system comprises an angular feed and at least one mixing device. In some embodiments, an apparatus of the present invention comprises an angular feed attached to the ultraviolet-transmissive conduit such that a fluid flowing into the ultraviolet-transmissive conduit undergoes rotational mixing. In some embodiments, the angular feed comprises an inlet having a first diameter and an outlet attached to a conduit having a second diameter, wherein the second diameter is greater than the first diameter. Not being bound by any particular theory, mixing of the fluid within the ultraviolet-transmissive conduit provides that substantially all of the flowing fluid is irradiated despite non-uniform irradiance of the ultraviolet-transmissive conduit.

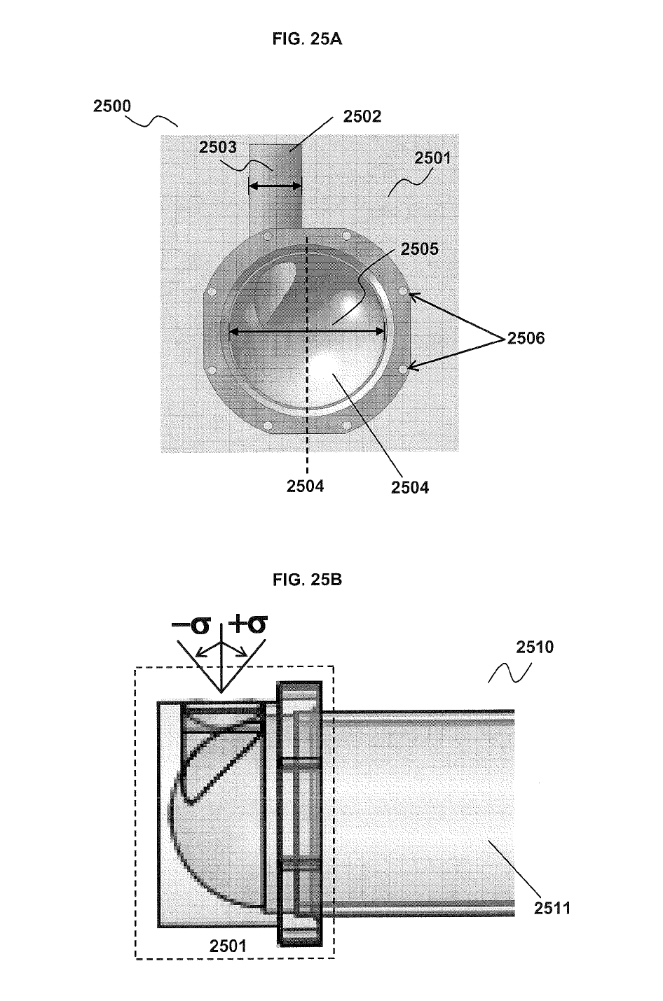

FIGS. 25A-25B provide cross-sectional representations of an angular feed and a portion of an apparatus of the present invention. Referring to FIG. 25A, the cross-sectional schematic, 2500, provides an end-on view of an angular feed, 2501, comprising an inlet, 2502, having a first diameter, 2503, and an outlet, 2504, having a second diameter, 2505. The second diameter, 2505, is greater than the first diameter 2503. In some embodiments, the second diameter, 2504, is the same as the diameter of the ultraviolet-transmissive conduit. Not being bound by any particular theory, positioning of the inlet portion of the angular feed, 2502, relative to the centerline, 2504, of an elliptical bulb controls the type and extent of mixing of a fluid that is flowed there through.

Referring to FIG. 25A, in some embodiments, the angular feed includes a means of attachment, 2509, suitable for affixing the angular feed on an ultraviolet-transmissive conduit. Suitable means of attachment include, but are not limited to, a flange (e.g., gasket-type, bolt-type, and any of ASME-approved flanges), compression fittings (e.g., SWAGELOK®, and the like), a magnet, a weld, or any other methods for connecting pipe that are known in the art.

Referring to FIG. 25B, a cross-sectional representation, 2510, of a portion of an apparatus of the present invention is provided, wherein an angular feed, 2501, is attached to an ultraviolet-transmissive conduit, 2511. As described above, the second diameter of the outlet of the angular feed has a diameter substantially the same as that of the ultraviolet-transmissive conduit. Typically, the angular difference in the direction of fluid flow between the inlet and outlet of the angular feed is about 90°. However, variation of the angle of entry of the inlet portion of the angle feed, +σ and −σ, can be used to control the type and extent of rotational mixing of a fluid flowing within the ultraviolet-transmissive conduit. In some embodiments, σ is about 20° or less, about 15° or less, about 10° or less, or about 5° or less.

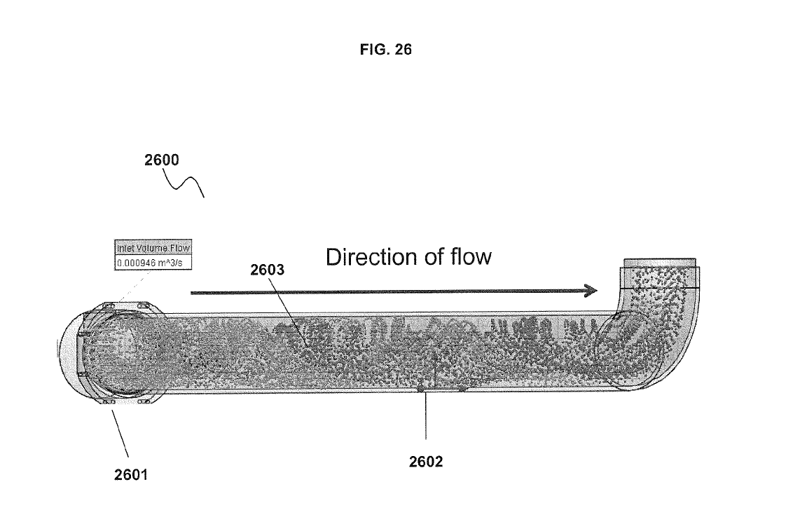

FIG. 26 provides a graphic representation, 2600, of the results of modeling the flow of fluid within an ultraviolet-transmissive conduit after passing through an angular feed, as provided in FIGS. 25A-25B. Referring to FIG. 26, the angular feed, 2601, induces rotational mixing in the flowing fluid, 2603, such that the fluid undergoes extensive mixing as it flows through the ultraviolet-transmissive conduit, 2602.

In some embodiments, a mixing system for use with the present invention comprises a mixing device. Mixing devices suitable for use with the present invention include, but are not limited to, fixed fins, rotating fins, fixed-angle baffles, variable-angle baffles, propellers (having, e.g., 2, 3, 4, 5, 6, 7, 8, or more radii), and the like, and combinations thereof. In some embodiments, a mixing device moves within the ultraviolet-transmissive conduit (i.e., traverses the length of the conduit). In some embodiments, a mixing device moves to change its angular position relative to a fluid path (e.g., a change in an angle of a baffle or fin). In some embodiments, a mixing device is in a fixed position within the ultraviolet-transmissive conduit. Not being bound by any particular theory, a mixing device located at a fixed point within the ultraviolet-transmissive conduit can facilitate uniform rotational mixing through the length of the ultraviolet-transmissive conduit.

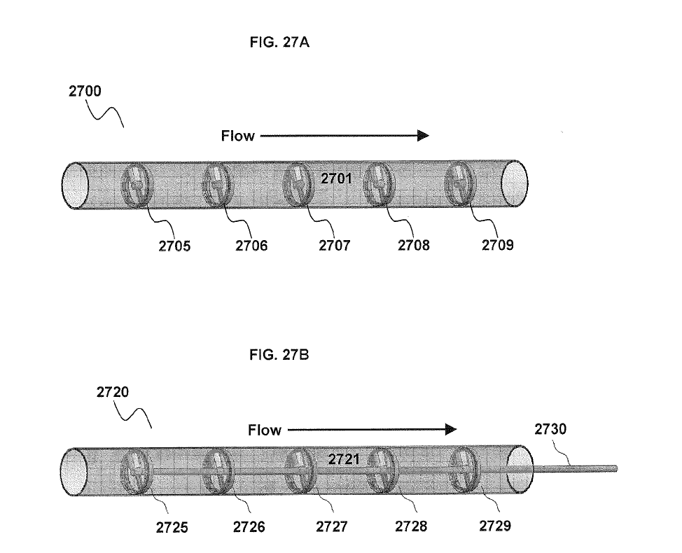

FIG. 27A provides a cross-sectional representation, 2700, of a conduit containing a plurality of mixing devices. Referring to FIG. 27A, a first mixing device, 2705, is positioned at the entry to the ultraviolet-transmissive conduit, 2701. The mixing device includes a pair of baffles in the fluidic flow path. Additional mixing devices, 2706, 2707, 2708 and 2709, are positioned along the conduit. In some embodiments, the mixing devices are connected by a shaft. In some embodiments, the shaft is hollow. FIG. 27B provides a cross-sectional representation, 2720, of a conduit containing a plurality of mixing devices. Referring to FIG. 27B, a first mixing device, 2725, is positioned at the entry to the ultraviolet-transmissive conduit, 2721. The mixing device includes a pair of baffles in the fluidic flow path. Additional mixing devices, 2726, 2727, 2728 and 2729, are positioned along the conduit. The mixing devices are all connected by a hollow shaft, 2730.

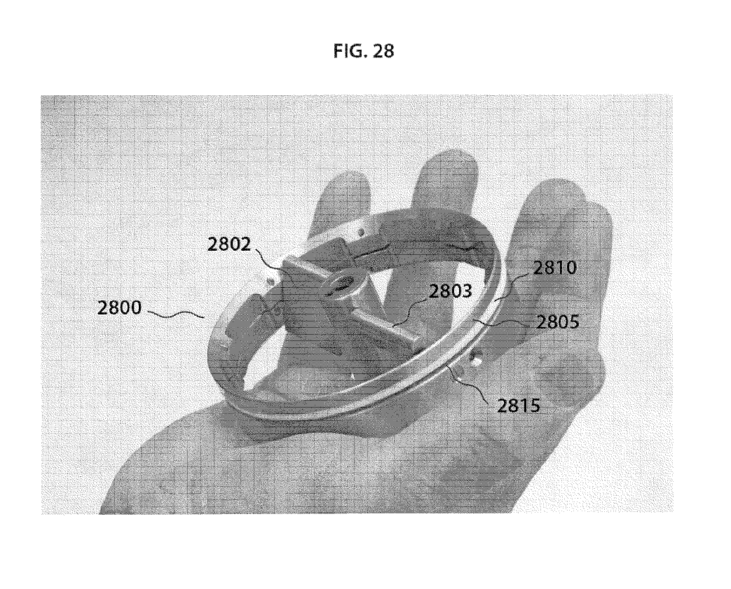

FIG. 28 shows a photograph of a prototype mixing device, 2800. The mixing device includes baffles, 2802 and 2803. The outer surface of the mixing device, 2805 which makes contact with the ultraviolet conduit, contains wiper blades, 2810, that can be used to clean the conduit. The mixing device also contains fluidic channels, 2815, that connect the hollow shaft to the wiper blades through the center of the baffles 2802 and 2803, and can be used to deliver cleaning chemicals from the hollow shaft to the wiper blades.

In some embodiments, an apparatus of the present invention for the treatment of a fluid comprises a cylindrical chamber that includes a reflective inner surface, wherein the cylindrical chamber has an elliptical cross-section. The apparatus also comprises an ultraviolet-transmissive conduit suitable for transmitting a fluid, traversing a length of the cylindrical chamber, and an angular feed attached to the ultraviolet-transmissive conduit, wherein the angular feed comprises an inlet having a first diameter and an outlet having a second diameter, wherein the second diameter is greater than the first diameter. One or more ultraviolet light sources positioned within the cylindrical chamber, wherein the ultraviolet light sources provide a non-uniform irradiance of the ultraviolet-transmissive conduit, and wherein substantially all of a fluid flowing through the ultraviolet-transmissive conduit is irradiated by ultraviolet light

As discussed herein elsewhere, in some embodiments an apparatus comprises an ultraviolet-transmissive sheath surrounding the ultraviolet light sources. In some embodiments, the substantially reflective inner surface of the cylindrical chamber comprises aluminum.

### Methods of Treating a Fluid

The present invention also provides methods of treating a fluid, e.g., disinfecting water, utilizing the apparatus of the present invention. As described herein, in exemplary embodiments, the fluid that is treated/disinfected is water, including drinking water, municipal waste water, industrial waste water, sewer water, storm water, etc.

In some embodiments, the methods are suitable for treating water that is not heavily contaminated with light-absorbing species and the like. In such embodiments, an ultraviolet-transmissive conduit has a substantially circular cross-section of 25 mm to 75 mm, 25 mm to 60 mm, 25 mm to 50 mm, 30 mm to 75 mm, 30 mm to 60 mm, 40 mm to 75 mm, 40 mm to 60 mm, 50 mm to 75 mm, about 25 mm, about 40 mm, about 50 mm, about 60 mm, or about 75 mm in diameter, and the ultraviolet light sources (e.g., first and second UV light sources) provide a total dosage of 5 mJ/cm² to 125 mJ/cm², 5 mJ/cm² to 100 mJ/cm², 5 mJ/cm² to 75 mJ/cm², 10 mJ/cm² to 125 mJ/cm², 10 mJ/cm² to 100 mJ/cm², 10 mJ/cm² to 75 mJ/cm², 25 mJ/cm² to 125 mJ/cm², 25 mJ/cm² to 100 mJ/cm², 25 mJ/cm² to 75 mJ/cm², 50 mJ/cm² to 125 mJ/cm², 50 mJ/cm² to 100 mJ/cm², or 50 mJ/cm² to 75 mJ/cm² to the fluid flowing through the ultraviolet-transmissive conduit. In such embodiments, a fluid enters the ultraviolet-transmissive conduit at a rate of 100 gallons per minute or less, 90 gallons per minute or less, 80 gallons per minute or less, 70 gallons per minute or less, 60 gallons per minute or less, 50 gallons per minute or less, 40 gallons per minute or less, 30 gallons per minute or less, 20 gallons per minute or less, 10 gallons per minute or less. In some embodiments, a fluid entering the ultraviolet-transmissive conduit has an ultraviolet transmission of at least 60%, at least 70%, at least 80%, at least 90%, at least 95%, or at least 99% (i.e., at λ=254 nm for a fluid sample having a path length of 1 cm).

In some embodiments, the methods are suitable for treating water that is heavily contaminated with light-absorbing species and the like. In such embodiments, the ultraviolet-transmissive conduit has a substantially circular cross-section of 60 mm to 125 mm, 70 mm to 125 mm, 80 mm to 125 mm, 90 mm to 125 mm, 100 mm to 125 mm, about 75 mm, about 100 mm, or about 125 mm in diameter, and the ultraviolet light sources provide a total energy density of 50 mJ/cm² to 250 mJ/cm², 50 mJ/cm² to 200 mJ/cm², 50 mJ/cm² to 150 mJ/cm², 100 mJ/cm² to 250 mJ/cm², 100 mJ/cm² to 200 mJ/cm², 100 mJ/cm² to 150 mJ/cm², 125 mJ/cm² to 250 mJ/cm², 125 mJ/cm² to 200 mJ/cm², or 125 mJ/cm² to 150 mJ/cm² to the fluid flowing through the ultraviolet-transmissive conduit. In some embodiments, a flowing fluid enters the ultraviolet-transmissive conduit at a rate of 25 gallons per minute or more, 50 gallons per minute or more, 75 gallons per minute or more, 90 gallons per minute or more, 100 gallons per minute or more, 125 gallons per minute or more, or 150 gallons per minute or more. In some embodiments, a fluid entering the ultraviolet-transmissive conduit has an ultraviolet transmission of 90% or less, 80% or less, 70% or less, 60% or less, or 50% or less (i.e., at λ=254 nm for a fluid sample having a path length of 1 cm).

### Cleaning System

In further embodiments, the present invention provides a system for cleaning at least an inner surface of a UV transmissive conduit. Such a system suitably comprises an interior conduit cleaning unit. In some embodiments, a cleaning unit includes a cleaning material coupled to a magnetic support, and an exterior conduit sleeve having at least one magnetic component. Suitably, the cleaning material is UV-resistant or coated with a UV-resistant material. Methods of cleaning at least an inner surface of UV transmissive conduit are also provided.

In some embodiments, an apparatus comprises a cleaning system. Continuous high-intensity irradiance of a wide variety of different fluids can lead to deposition of minerals and/or metals from the fluid as well as cross-linking reactions of organic compounds that can coat the interior of the ultraviolet-transmissive conduit. For example, iron, manganese, humic acids, tannins, and the like can deposit from water onto the interior surface of an ultraviolet-transmissive conduit.

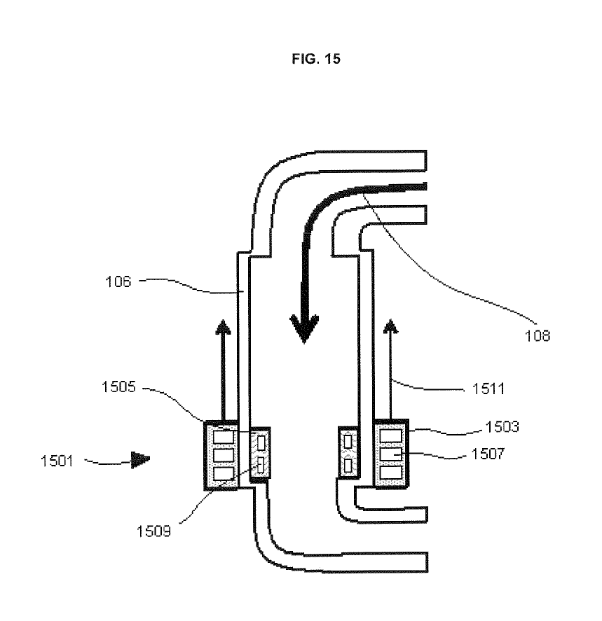

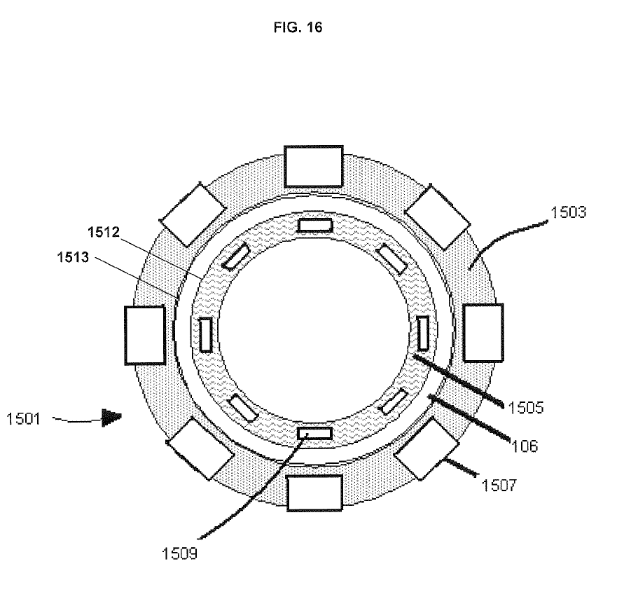

FIG. 15 is a sectional view of transmissive conduit 106, having a low-profile cleaning system 1501 for cleaning ultraviolet-transmissive conduit 106, in accordance with an embodiment presented herein. FIG. 16 is a cross-sectional view of system 1501. System 1501 can be integrated with any apparatus described herein. System 1501 serves to clean at least the inner surface of an ultraviolet-transmissive conduit 106, and can also be used to clean an outer surface of an ultraviolet-transmissive conduit.

The cleaning system 1501 includes an exterior (or outer) sleeve 1503 disposed around the outer surface of ultraviolet-transmissive conduit 106. The exterior sleeve 1503 can be a hollow cylindrical sleeve that either fully or partially surrounds the circumference of conduit 106. Exterior sleeve 106 includes at least one magnetic component 1507. The magnetic component can be embedded in, encapsulated, affixed to, or otherwise integrated with the exterior sleeve as either fully integrated (i.e., fully within the surrounding material) or partially integrated (i.e., partially within and partially protruding from the material), and can include structures formed by, e.g., press-fitting, forming, molding, gluing, etc. As used herein, “magnetic” refers to materials “having the properties of a magnet,” “capable of being magnetized,” or “capable of being attracted by a magnet.” In one embodiment, exterior sleeve 1503 includes a plurality of discreet magnetic components 1507. In another embodiment, exterior sleeve 1503 includes a single magnetic component 1507. In another embodiment, exterior sleeve 1503 includes one magnetic component 1507 having the form of a hollow cylinder embedded in exterior conduit sleeve 1503. Magnetic components 1507 can be formed of ferromagnetic materials such as, but not limited to, iron, cobalt, nickel, and the like, and alloys thereof. Magnetic components 1507 can be cube shaped or cylindrically shaped (or any other shape). Magnetic components 1507 can range in size from cubic millimeters to cubic centimeters, suitably from 1 mm³ to 50 mm³, or 1 mm³ to 10 mm³, suitably 1 mm³ to 3 mm³.

Cleaning system 1501 also includes a wiper 1505 disposed within conduit 106. The wiper 1505 can take the form of a hollow cylindrical ring adjacent to the interior surface of conduit 106. The wiper 1505 includes at least one magnetic support 1509 embedded therein. In one embodiment, the wiper 1505 includes a plurality of discreet magnetic supports 1509. In another embodiment, wiper 1505 includes one magnetic support 1509. In yet another embodiment, wherein wiper 1505 includes one magnetic support 1509, such magnetic support takes the form of a hollow cylinder embedded in the wiper 1505. Magnetic supports 1509 can be formed of ferromagnetic materials, including iron, cobalt, nickel, composites thereof, or materials equivalent thereto. Magnetic supports 1509 can be cube shaped or cylindrically shaped (or any other shape). Magnetic supports 1509 can range in size from cubic millimeters to cubic centimeters, suitably from 1 mm³ to 50 mm³, or 1 mm³ to 10 mm³, suitably 1 mm³ to 3 mm³.

Suitably, both the wiper 1505 and the exterior sleeve 1503 are substantially permeable to UV light so as to not impact or limit the amount of UV light reaching the fluid 108. In other embodiments, simply by utilizing a wiper 1505 and exterior sleeve 1503 that are small (i.e., having a short length), the impact on the amount of UV light reaching fluid 108 can be minimized.

In one embodiment, wiper 1505 takes the form of a glass ring having magnetic supports 1509 embedded therein. Use of a glass ring negates the need for a UV resistant coating on interior conduit cleaning unit 1505. In one embodiment, the wiper 1505 can be designed as thin as 1 mm to 5 mm in thickness, and thus provide minimal interference with the flow of fluid 108 through conduit 106. In alternative embodiments, wiper 1505 can be formed of any machinable or moldable material that can be easily coated. The wiper 1505 is preferably formed of a water-resistant/water-proof material. For example, the wiper 1505 can be formed of polymers such as PVC, polyesters, teflon, plexiglass (polycarbonates), or materials equivalent thereto.

In one embodiment, wiper 1505 further includes a contact surface 1512 for cleaning the inner surface of conduit 106, as further described below. As used herein, “contact surface” refers to any material that functions to clean the interior surface of conduit 106. The contact surface can comprise rubber, teflon, or any other equivalent material that exhibits appropriate friction force when moved against the surface of conduit 106 (e.g., a polymer, a sponge (natural or synthetic), and the like). In one embodiment, the contact material is UV-resistant. In another embodiment, the contact material is coated with a UV-resistant coating. For example, the wiper 1505 (and/or contact material 1512) can include a thin layer (e.g., 100 nm to 10 mm) of a UV-resistant material such as a metal, an oxide, a UV-resistant plastic, or any material equivalent thereto, disposed thereon. As used herein “UV-resistant coating” refers to a material that substantially limits or eliminates degradation of the contact material 1512 and/or wiper 1505, when exposed to UV light. The UV-resistant material can be coated, sprayed, painted, deposited, electrodeposited, deposited electrolessly, or vapor deposited on the various surfaces. In one embodiment, exterior sleeve 1503 further comprises a contact surface 1513 for cleaning the outer surface of conduit 106.

Exterior sleeve 1503 is disposed around the outer surface of ultraviolet-transmissive conduit 106 in concentric alignment with the wiper 1505 such that magnetic components 1507 correspond to, and align with, magnetic supports 1509 in interior conduit cleaning unit 1505. The terms “correspond to” or “align with” are intended to merely imply that the arrangement creates a magnetic attraction between wiper 1505 and exterior sleeve 1503. Thus, movement, e.g., a sliding motion (or rolling motion) of exterior sleeve 1503 along the outer surface of conduit 106 (represented by arrows 1511) causes a respective movement of the wiper 1505 along the inner surface of the ultraviolet-transmissive conduit. The magnetic attraction between wiper 1505 and exterior sleeve 1503 is suitably strong enough so as to move the wiper 1505 despite the counteracting force of the fluid 108 flowing through the ultraviolet-transmissive conduit. For example, small and strong magnets, e.g., neodymium magnets or magnets equivalent thereto, can be used for the design of the interior conduit cleaning unit 1505 and exterior conduit sleeve 1503.

Exterior sleeve 1503 can be moved (i.e., driven) manually or by a motor. For example, a lead screw system or motor-wheel system that rides on the outer surface of the ultraviolet-transmissive conduit 106 can be employed. In addition, rollers can be used between the exterior sleeve 1503 and ultraviolet-transmissive conduit 106. When system 1501 is not in use, the wiper 1505 suitably rests against a lip on the connecting pipe, as shown in FIG. 15.

As such, system 1501 can be used in a method of cleaning at least an inner surface of an ultraviolet-transmissive conduit (e.g., conduit 106) in an apparatus of the present invention. The method of cleaning includes providing within ultraviolet-transmissive conduit 106 a wiper 1505 having a contact material 1512 coupled to a magnetic support 1509. The method also includes positioning an exterior sleeve 1503, having at least one magnetic component 1507, on an outer surface of ultraviolet-transmissive conduit 106 so as to create a magnetic attraction with the wiper 1505. The method further includes moving exterior (i.e., sliding) sleeve 1503 along the outer surface of ultraviolet-transmissive conduit 106 so as to create a respective movement (i.e., sliding) of the wiper 1505 along the inner surface of the ultraviolet-transmissive conduit 106.

Further provided herein is a method of cleaning an apparatus of the present invention, the method comprising providing a wiper within the ultraviolet-transmissive conduit and positioned in contact with an inner surface of the ultraviolet-transmissive conduit, wherein the wiper is formed of a contact material embedded with a plurality of magnetic supports and coated with a UV-resistant coating. The method comprises positioning an exterior sleeve around an outer surface of the ultraviolet-transmissive conduit in concentric alignment with the wiper, wherein the exterior sleeve includes a plurality of magnetic components corresponding to the plurality of magnetic supports in the wiper such that there is a magnetic attraction between the wiper and the exterior sleeve. The method also includes moving the exterior sleeve along the outer surface of the ultraviolet-transmissive conduit to cause a respective movement of the wiper along the inner surface of the ultraviolet-transmissive conduit.

In some embodiments, an apparatus of the present invention comprises a wiper suitable for traversing at least a portion of the ultraviolet-transmissive conduit. FIG. 17 provides a three-dimensional schematic representation, 1700, of a wiper suitable for use with the present invention. Referring to FIG. 17, the apparatus includes an ultraviolet-transmissive conduit, 1706, and a wiper, 1701, suitable for traversing at least a portion of the ultraviolet-transmissive conduit, 1710. In some embodiments, a wiper 1701 includes a contact surface, 1702, suitable for mechanically cleaning an inner surface of the ultraviolet-transmissive conduit. In some embodiments, the wiper 1701, comprises a rigid member, 1703, suitable for controlling the position of the wiper within the ultraviolet-transmissive conduit, wherein the wiper is connected to the rigid member by one or more spokes 1704. Suitable rigid members for use with the present invention include a rail, a track, a guide wire, a threaded shaft, a piston, a screw-drive, and the like. While two spokes, 1704, are depicted in FIG. 17, configurations comprising one, three, four, five, six, seven, eight, nine, ten, eleven, or twelve spokes can be employed. The spokes can have, for example, a planar, a triangular, an airfoil, or an ellipsoidal cross-sectional shape, and in some embodiments can be angled relative to the long-axis of the ultraviolet-transmissive conduit. For example, FIG. 17 provides a schematic diagram of spokes, 1704, having a planar shape in which the spokes are tilted at an angle relative to the x-axis of the ultraviolet transmissive conduit, 1710. In some embodiments, the wiper rotates as it traverses the ultraviolet-transmissive conduit. The rigid member, 1703, can optionally include a support member, 1713, suitable for rigidly affixing at least a portion of the rigid member to, for example, an end of the ultraviolet-transmissive conduit, a pipe connected thereto, and/or a flange.

In some embodiments, a rigid member and/or a wiper comprises a metal such as stainless steel and the like. In some embodiments, a contact material comprises rubber, a perfluorinated polymer (e.g., TEFLON®, available from E.I. DuPont de Nemours and Co.), a sponge, or another material suitable for mechanically contacting an inner surface of the ultraviolet-transmissive conduit without degrading, abrading, or otherwise damaging the inner surface.

An apparatus of the present invention can include one or more wipers. In some embodiments, an apparatus comprises a single wiper that traverses the length of the ultraviolet-transmissive conduit. Alternatively, a plurality of wipers (e.g., two, three, four, five, six, seven, eight, or more wipers) are placed within the ultraviolet transmissive conduit, wherein each wiper cleans a section of the conduit (i.e., in series). The sections can be partially overlapping or separate from one another.

In some embodiments, a wiper comprises a reservoir suitable for containing a chemical. As used herein, a “reservoir” is a compartment or portion of the wiper suitable for containing a chemical and releasing the chemical in a controlled manner. A reservoir can include an adsorbent material and the like suitable for taking up and then slowly releasing a chemical. Chemicals suitable for use with a cleaning apparatus of the present invention such as a wiper include those materials “Generally Recognized As Safe” by the United States Food and Drug Administration. Chemicals suitable for use in and/or with an apparatus of the present invention include, but are not limited to, detergents, surfactants, metal chelators (e.g., EDTA and the like), and the like, and combinations thereof.

It will be readily apparent to one of ordinary skill in the relevant arts that other suitable modifications and adaptations to the methods and applications described herein can be made without departing from the scope of the invention or any embodiment thereof. Having now described the present invention in detail, the same will be more clearly understood by reference to the following examples, which are included herewith for purposes of illustration only and are not intended to be limiting of the invention.

### EXAMPLES

### Example 1

### Determination of Optimal Conduit Diameter Based on Irradiance Mapping

The irradiance profile of the ultraviolet-transmissive conduit was mapped to a Gaussian curve and solved for the theoretical optimum diameter. Assumptions included in the model (all to take into account a worse-case scenario) were: (a) no axial fluid mixing within the ultraviolet-transmissive conduit; (b) a uniform velocity distribution in the ultraviolet-transmissive conduit; (c) the irradiance map is independent of conduit diameter change; and (d) the irradiance profile has a Gaussian distribution from the given geometry of the reflective chamber.

The irradiance profile was then fit with a Gaussian bell curve. The variables μ and σ in Equations 2 and 3 below were then determined to model the center position and width of the Gaussian curve.

For a 1-dimensional irradiance profile:

$$I ( x ) = \frac{1}{σ \sqrt{2 π}} {e}^{- \frac{{( x - μ )}^{2}}{2 {σ}^{2}}} . \qquad ( 2 )$$

For a 2-dimensional irradiance profile:

$$I ( x , y ) = A \cdot {e}^{- ( \frac{{( x - {μ}_{x} )}^{2}}{2 {σ}_{x}^{2}} + \frac{{( x - {μ}_{y} )}^{2}}{2 {σ}_{y}^{2}} )} . \qquad ( 3 )$$

Ultraviolet light dosage transmitted to the fluid within the ultraviolet-transmissive conduit is a function of diameter of the ultraviolet-transmissive conduit. For a fixed flow rate (Q), conduit radius (x), flow speed (v) and residence time (t) are governed by

Equation 4:

Q=(π·x²)·v (4).

As the length of conduit (d) is constant, the residence time (t), equals:

$$t = \frac{d}{v} = ( \frac{d \cdot π \cdot {x}^{2}}{Q} ) . \qquad ( 5 )$$

Dosage (D) is equal to irradiance (1) multiplied by residence time (t), thus:

$$D ( x ) = I ( x ) \cdot {x}^{2} \cdot ( \frac{π \cdot d}{Q} ) = \frac{1}{σ \sqrt{2 π}} {e}^{- \frac{{( x )}^{2}}{2 {σ}^{2}}} \cdot {x}^{2} \cdot ( \frac{π d}{Q} ) . \qquad ( 6 )$$

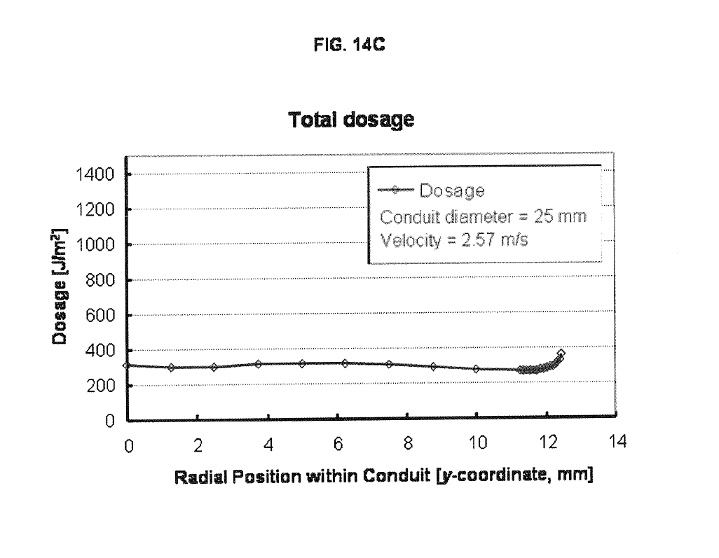

By differentiating D(x), x can be solved to achieve a maximum dosage. An example demonstrating the use of this analysis is shown in FIGS. 14A-14C. Based on a simulated irradiation profile, and a flow rate of 20 gallons per minute, it was determined that an optimal conduit diameter for these characteristics was 32 mm. As shown in FIG. 14A, a conduit diameter of 50 mm resulted in fluid velocity of 0.64 m/s, and the dosage profile shown, with a high dosage at the center of the ultraviolet-transmissive conduit (position=0), but dramatically reduced dosage at the edges of the ultraviolet-transmissive conduit. In contrast, a 32 mm conduit diameter resulted in a fluid velocity of 1.57 m/s, and the dosage profile shown in FIG. 14B—overall a more uniform dosage distribution. As shown in FIG. 14C, reducing the ultraviolet-transmissive conduit diameter to 25 mm increased the velocity to 2.57 m/s, however the dosage delivered to the fluid was reduced.

In summary, a theoretical optimal conduit diameter of 2√2σ (assuming no axial mixing) was determined. Increasing the velocity of fluid through the ultraviolet-transmissive conduit by reducing the diameter resulted in a more uniform dosage distribution. However, below an optimal value, the decrease in diameter resulted in a decrease in the average dose delivered to the fluid. In addition, at diameters larger than an optimal value, although average dosage delivered was higher, it caused a dramatic decrease in dosage at the circumference of the ultraviolet-transmissive conduit. Suitably, where a conduit does introduce positive fluid mixing effects, a conduit diameter slightly larger than the estimated optimal value can be used in order to take advantage of the high dosage at the center of the ultraviolet-transmissive conduit that occurs at lower fluid velocity.

### Example 2

### Ultraviolet Treatment Apparatus

An apparatus of the present invention was prepared using an ultraviolet-transmissive conduit (A Grade 214LD fused quartz pipe from GE) having a diameter of 7 cm, a length of 0.9 m, and a thickness of 5 mm. The ultraviolet-transmissive conduit was located within a cylindrical chamber having a polished aluminum reflective inner surface. The cylindrical chamber has an ellipsoidal cross-section with a major axis length of 15 cm, a minor axis length of 14.5 cm, and an eccentricity of 0.26. The ultraviolet-transmissive conduit was positioned at a second focal point of the ellipsoidal cross-section, and a first ultraviolet light source was positioned at a first focal point of the ellipsoidal cross-section. The distance between the first ultraviolet source and the outer surface of the ultraviolet-transmissive conduit was 1-5 cm. A second ultraviolet light was positioned on the major axis of the ellipsoidal cross-section at a point between the first ultraviolet light source and the ultraviolet-transmissive conduit. Both the first and the second ultraviolet light sources were 60 W Philips TUV PL-L high output U-lamps. Each lamp had a length of 41 cm and had two bulbs connected at the far end from the socket where the two bulbs had a spacing of 39 mm. Each bulb had a diameter of 18 mm. The distance between the second ultraviolet source and the outer surface of the ultraviolet-transmissive conduit was 2-6 cm.

Angular feeds (double-90° stainless steel piping having a 7 cm diameter) were affixed to the inlet to and outlet from the ultraviolet-transmissive conduit. A flow diffuser was attached to the inlet angular feed, and immediately before the flow diffuser, a 2.5 cm diameter pipe was expanded to a diameter of 7 cm.

Water for treatment was flowed into the apparatus at a rate of 15 GPM and the flowing water was irradiated with a total dose of 52 mJ/cm².

### Example 3

### Viral Log Reduction Test

A bateriaphage virus MS-2 that infects a specific strain of E. Coli was used in the testing. The test followed the protocol as described in NSF/ANSI Standard 55. MS-2 was introduced to the apparatus by passing through the unit as described in details in Example 2. Influent and effluent samples were collected at the same time at different flow rates. The samples with different dilutions were introduced to the E. Coli-loaded agar plates, wherein the E. Coli. was genetically modified such that it can grow if and only if MS-2 is present. The number of E. Coli colonies on each plate was then counted after an incubation time of 1824 hours for E. Coli. colonies to grow to sufficient size. The Log MS-2 reduction was determined by subtracting the counts of the effluent sample from the corresponding counts of the influent sample on a log scale.

A calibrated, collimated ultraviolet source test was used to create standard curve to correlate the Log MS-2 reduction to UV dose by following the same plating procedure described herein for samples irradiated for a set of time with a calibrated UV source. The log reduction was 2.29+/−0.07 at a rate of 15 GPM and 2.91+/−0.13 at a rate of 10 GPM. The sterilight system was a Sterilight Platinum SPV-950 system, NSF certified to Class A (NSF/ANSI Standard 55) for 14.9 GPM. The overall Log MS-2 reduction performance of the apparatus of the current invention was comparable to Class A-certified, bulb-in-water Sterilight system.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

1. An apparatus for the treatment of a fluid, comprising:
(a) a cylindrical chamber that includes a reflective inner surface, wherein the cylindrical chamber has an elliptical cross-section that includes a major axis;
(b) an ultraviolet-transmissive conduit suitable for transmitting a fluid, the ultraviolet-transmissive conduit positioned at a first point on the major axis of the elliptical cross-section and traversing a length of the cylindrical chamber;
(c) a mixing system configured to induce mixing of a fluid flowed through the ultraviolet-transmissive conduit;
(d) a first ultraviolet light source and a second ultraviolet light source positioned within the cylindrical chamber, wherein the first and second ultraviolet light sources are substantially equidistant from the ultraviolet-transmissive conduit and on opposite sides of the major axis,
wherein the first and second ultraviolet light sources provide a non-uniform irradiance of the ultraviolet-transmissive conduit, and wherein substantially all of a fluid flowed through the ultraviolet-transmissive conduit is irradiated by ultraviolet light.

2-7. (canceled)

8. An apparatus for the treatment of a fluid, comprising:
(a) a cylindrical chamber having a double-elliptical cross-section provided by partially overlapping first and second ellipses, wherein the ellipses have co-linear major axes and overlapping second focal points, wherein the cylindrical chamber includes a reflective inner surface;
(b) an ultraviolet-transmissive conduit suitable for transmitting a fluid, the ultraviolet-transmissive conduit positioned at the overlapping second focal points of the first and second ellipses, wherein the ultraviolet-transmissive conduit traverses a length of the cylindrical chamber;
(c) a mixing system configured to induce mixing of a fluid flowed through the ultraviolet-transmissive conduit;
(d) a first ultraviolet light source and a second ultraviolet light source positioned within the cylindrical chamber, wherein the first and second ultraviolet light sources are substantially equidistant from the ultraviolet-transmissive conduit and on opposite sides of the major axis of the first ellipse of the double-elliptical cross-section; and
(e) a third ultraviolet light source and a fourth ultraviolet light source positioned within the cylindrical chamber, wherein the third and fourth ultraviolet light sources are substantially equidistant from the ultraviolet-transmissive conduit and on opposite sides of the major axis of the second ellipse of the double-elliptical cross-section,
wherein the first, second, third, and fourth ultraviolet light sources provide a non-uniform irradiance of the ultraviolet-transmissive conduit, and wherein substantially all of a fluid flowed through the ultraviolet-transmissive conduit is irradiated by ultraviolet light.

9. An apparatus for the treatment of a fluid, comprising:
(a) a cylindrical chamber having a double-elliptical cross-section provided by partially overlapping first and second ellipses, wherein the ellipses have co-linear major axes and wherein the cylindrical chamber includes a reflective inner surface;
(b) an ultraviolet-transmissive conduit suitable for transmitting a fluid, wherein a first portion of the ultraviolet-transmissive conduit traverses a length of the cylindrical chamber and is positioned at a first point on the major axis of the first ellipse, wherein a second portion of the ultraviolet-transmissive conduit traverses a length of the cylindrical chamber and is positioned at a first point on the major axis of the second ellipse;
(c) a mixing system configured to induce mixing of a fluid flowed through the ultraviolet-transmissive conduit;
(d) a first ultraviolet light source and a second ultraviolet light source positioned within the cylindrical chamber, wherein the first and second ultraviolet light sources are substantially equidistant from the first portion of the ultraviolet-transmissive conduit and on opposite sides of the major axis of the first ellipse of the double-elliptical cross-section;
(e) a third ultraviolet light source and a fourth ultraviolet light source positioned within the cylindrical chamber, wherein the third and fourth ultraviolet light sources are substantially equidistant from the second portion of the ultraviolet-transmissive conduit and on opposite sides of the major axis of the second ellipse of the double-elliptical cross-section; and
(f) a fifth ultraviolet light source positioned within the cylindrical chamber between the first and second portions of the ultraviolet-transmissive conduit and on the overlapping major axes of the first and second ellipses,
wherein the first, second, third, fourth, and fifth ultraviolet light sources provide a non-uniform irradiance of the first and second portions of the ultraviolet-transmissive conduit, and wherein substantially all of a fluid flowed through the ultraviolet-transmissive conduit is irradiated by ultraviolet light.

10-13. (canceled)

14. An apparatus for the treatment of a fluid, comprising:
(a) an ultraviolet-transmissive conduit suitable for containing a flowing fluid, the ultraviolet-transmissive conduit positioned within and traversing a length of a cylindrical chamber that includes a reflective inner surface;
(b) a mixing system configured to induce mixing of a fluid flowed through the ultraviolet-transmissive conduit; and
(c) a plurality of ultraviolet light sources positioned in an even distribution around the ultraviolet-transmissive conduit, each ultraviolet light source including a parabolic reflector,
wherein the ultraviolet light sources provide a non-uniform irradiance of the ultraviolet-transmissive conduit, and wherein substantially all of a fluid flowed through the ultraviolet-transmissive conduit is irradiated by ultraviolet light.

15-33. (canceled)

34. A method of treating a fluid, the method comprising:
(a) directing a fluid through the ultraviolet-transmissive conduit of the apparatus of claim 1; and
(b) generating ultraviolet light using the first and second ultraviolet light sources,
wherein substantially all of the fluid flowing through the ultraviolet-transmissive conduit is irradiated by the ultraviolet light.

35-37. (canceled)

38. A method of treating a fluid, the method comprising:
(a) directing a flowing fluid through the ultraviolet-transmissive conduit of the apparatus of claim 8; and
(b) generating ultraviolet light using the ultraviolet light sources,
wherein substantially all of the fluid flowing through the ultraviolet-transmissive conduit is irradiated by the ultraviolet light.

39. A method of treating a fluid, the method comprising:
(a) directing a flowing fluid through the ultraviolet-transmissive conduit of the apparatus of claim 9; and
(b) generating ultraviolet light using the ultraviolet light sources,
wherein substantially all of the fluid flowing through the ultraviolet-transmissive conduit is irradiated by the ultraviolet light.

40-42. (canceled)

43. A method of treating a fluid, the method comprising:
(a) directing a flowing fluid through the ultraviolet-transmissive conduit of the apparatus of claim 14; and
(b) generating ultraviolet light using the ultraviolet light sources,
wherein substantially all of the fluid flowing through the ultraviolet-transmissive conduit is irradiated by the ultraviolet light.

44. An apparatus for the treatment of a fluid, comprising:
(a) a cylindrical chamber that includes a reflective inner surface, wherein the cylindrical chamber has an elliptical cross-section;
(b) an ultraviolet-transmissive conduit suitable for transmitting a fluid, traversing a length of the cylindrical chamber;
(c) an angular feed attached to the ultraviolet-transmissive conduit, wherein the angular feed comprises an inlet having a first diameter and an outlet having a second diameter, wherein the second diameter is greater than the first diameter;
(d) one or more ultraviolet light sources positioned within the cylindrical chamber,
wherein the ultraviolet light sources provide a non-uniform irradiance of the ultraviolet-transmissive conduit, and wherein substantially all of a fluid flowed through the ultraviolet-transmissive conduit is irradiated by ultraviolet light.
